(19) United States
(12) Patent Application Publication
(10) Pub. No.: US 2026/0297321 A1
(43) Pub. Date: Oct. 1, 2026

(54) RESIN PARTICLE, METHOD FOR MANUFACTURING RESIN PARTICLE, TONER RESIN PARTICLE, TONER, DEVELOPER, TONER STORAGE UNIT, AND IMAGE FORMING APPARATUS

(71) Applicants: Junichi WATANABE, Shizuoka (JP); Tsuneyasu NAGATOMO, Shizuoka (JP); Taro ARAKI, Shizuoka (JP)

(72) Inventors: Junichi WATANABE, Shizuoka (JP); Tsuneyasu NAGATOMO, Shizuoka (JP); Taro ARAKI, Shizuoka (JP)

(21) Appl. No.: 19/578,934

(22) Filed: Mar. 26, 2026

(30) Foreign Application Priority Data
Apr. 1, 2025 (JP) 2025-060595

(51) Int. Cl. C08L 67/02; C08J 3/12; C08J 3/22; C08K 3/04; G03G 9/08; G03G 9/09; G03G 9/093

(52) U.S. Cl. CPC C08L 67/025; C08J 3/126; C08J 3/226; C08K 3/04; G03G 9/0804; G03G 9/0815; G03G 9/0904; G03G 9/09328; G03G 9/09371; C08J 2367/02; C08J 2467/02; C08L 2205/025; C08L 2207/53; C08L 2310/00

(57) ABSTRACT

A resin particle comprising a binder resin including an amorphous polyester resin A, an amorphous polyester resin B, and a crystalline polyester resin is provided. The resin particle has a core-shell structure including a core layer and a shell layer, the core layer contains the amorphous polyester resin A and the crystalline polyester resin, and the shell layer contains the amorphous polyester resin B. A solubility parameter (SPa) of the amorphous polyester resin A, a solubility parameter (SPb) of the amorphous polyester resin B, and a solubility parameter (SPc) of the crystalline polyester resin satisfy relational expressions (1) to (3) below: SPa−SPc≤1.6 (1); 0.2≤SPb−Spa (2); and SPb≤11.6 (3), and a content of environmentally friendly components in the resin particle is 30% or more.

### CROSS-REFERENCE TO RELATED APPLICATIONS

This patent application is based on and claims priority pursuant to 35 U.S.C. § 119 (a) to Japanese Patent Application No. 2025-060595, filed on Apr. 1, 2025, in the Japan Patent Office, the entire disclosure of which is hereby incorporated by reference herein.

### BACKGROUND

### Technical Field

The present disclosure relates to a resin particle, a method for manufacturing a resin particle, a toner resin particle, a toner, a developer, a toner storage unit, and an image forming apparatus.

### Related Art

Resin materials such as the binder resin of a toner have relied almost entirely on petroleum resources.

Petroleum-derived resins release carbon dioxide into the atmosphere when discarded, contributing to global warming. In addition, because petroleum is a finite resource, there are concerns relating to the difficulty of sustainable utilization.

Given such a background, there is a demand to switch from petroleum-derived resins to environmentally friendly resins. Environmentally friendly resins include biomass resins and recycled resins. Biomass resins are made from renewable plant resources, and recycled resins are produced by recycling waste. The transition to sustainable materials is being advanced by using such environmentally friendly resins.

As the binder resin of a toner, the use of environmentally friendly resins such as polyesters using plant-derived propylene glycol, which is a renewable resource, as a monomer, polylactic acid (PLA), rosin compounds, and recycled polyethylene terephthalate (PET), are being investigated. Such materials have a lower environmental impact compared to petroleum-derived resins, and contribute to the manufacturing of sustainable products.

On the other hand, in order to exhibit the functions of a toner, basic characteristics such as low-temperature fixability, filming resistance, and heat resistant storage stability are preferable.

### SUMMARY

Embodiments of the present disclosure provide a resin particle comprising a binder resin including an amorphous polyester resin A, an amorphous polyester resin B, and a crystalline polyester resin. The resin particle has a core-shell structure including a core layer and a shell layer, the core layer contains the amorphous polyester resin A and the crystalline polyester resin, and the shell layer contains the amorphous polyester resin B. A solubility parameter (SPa) of the amorphous polyester resin A, a solubility parameter (SPb) of the amorphous polyester resin B, and a solubility parameter (SPc) of the crystalline polyester resin satisfy relational expressions (1) to (3) below: SPa−SPc≤1.6 (1); 0.2≤SPb−Spa (2); and SPb≤11.6 (3), and a content of environmentally friendly components in the resin particle is 30% or more.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating an image forming apparatus according to embodiments of the present disclosure; and

FIG. 2 is a schematic configuration diagram illustrating a process cartridge as a toner storage unit according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present disclosure, a resin particle that exhibits excellent environmental friendliness, and has excellent charging stability, heat resistant storage stability, and low-temperature fixability is provided.

### (Resin Particle)

The resin particle according to embodiments of the present disclosure is a resin particle containing at least a binder resin, and has a core-shell structure including a core layer and a shell layer. The binder resin includes an amorphous polyester resin A, an amorphous polyester resin B, and a crystalline polyester resin.

The core layer contains the amorphous polyester resin A and the crystalline polyester resin, the shell layer contains the amorphous polyester resin B, and a content of environmentally friendly components in the resin particle is 30% or more.

Furthermore, a solubility parameter (SPa) of the amorphous polyester resin A, a solubility parameter (SPb) of the amorphous polyester resin B, and a solubility parameter (SPc) of the crystalline polyester resin satisfy the following relational expressions (1) to (3).

$$Spa - Spc \leq 1.6 \qquad ( 1 )$$

$$0.2 \leq SPb - SPa \qquad ( 2 )$$

$$SPb \geq 11.6 \qquad ( 3 )$$

### (Amorphous Polyester Resin A)

The amorphous polyester resin A according to embodiments of the present disclosure is an amorphous polyester resin obtained by polycondensation of an alcohol monomer and a carboxylic acid monomer. It is desirable that the carboxylic acid includes one or more types of biomass-derived dicarboxylic acids having 6 or more carbon atoms, more preferably 8 or more carbon atoms.

### (Amorphous Polyester Resin B)

The amorphous polyester resin B according to embodiments of the present disclosure is an amorphous polyester resin obtained by polycondensation of an alcohol component and a carboxylic acid component. It is desirable that the content of environmentally friendly components is 0%.

### (Method for Manufacturing Resin Particle)

The method for manufacturing a resin particle according to embodiments of the present disclosure includes the following step a, step b, step c, and step d.

Step a: Preparing an oil phase in which an amorphous polyester resin A and a crystalline polyester resin are dissolved or dispersed in an organic solvent

Step b: Adding water to the oil phase to cause phase inversion from a water-in-oil dispersion liquid to an oil-in-water dispersion liquid

Step c: Aggregating particles in the oil-in-water dispersion liquid

Step d: Adding, after step c, an aqueous dispersion of an amorphous polyester resin B to the oil-in-water dispersion liquid to aggregate the amorphous polyester resin B in the aqueous dispersion to form a shell layer

### (Toner Resin Particle)

A toner resin particle according to embodiments of the present disclosure contains the resin particle according to embodiments of the present disclosure.

### (Toner)

A toner according to embodiments of the present disclosure contains the toner resin particle according to embodiments of the present disclosure.

The resin particle and the toner resin particle may contain other components such as a release agent and a colorant, if preferable.

Hereinafter, a resin particle, a method for manufacturing a resin particle, a toner resin particle, a toner, a developer, a toner storage unit, and an image forming apparatus according to embodiments of the present disclosure will be described. Note that the present disclosure is not limited to the embodiment described below, and can be changed within a range that those skilled in the art can conceive, such as other embodiments, additions, modifications, and deletions, and any aspect is included in the scope of the present disclosure as long as the actions and effects of the present disclosure are exhibited.

### <Environmentally Friendly Component>

Herein, “environmentally friendly component” means at least either a recycled resin or a plant-derived component.

In the resin particle, the content (A) of the environmentally friendly components is 30% by mass or more, and is preferably 50% by mass or more. The content (A) of the environmentally friendly components of 30% by mass or more is an amount that is desirable from the viewpoint of reducing the environmental impact.

### <<Recycled Resin>>

The recycled resin is not limited and can be selected as appropriate according to the intended purpose, and examples include, but are not limited to, recycled polyethylene terephthalate (PET) and recycled polybutylene terephthalate (PBT).

The component derived from polyethylene terephthalate (PET) or polybutylene terephthalate (PBT) is not limited if the component is derived from PET or PBT, and can be selected as appropriate according to the intended purpose.

The recycled polyethylene terephthalate (PET) is generally composed of ethylene glycol and terephthalic acid. Also, the recycled polybutylene terephthalate (PBT) is generally composed of butylene glycol and terephthalic acid. Therefore, examples of the components derived from PET or PBT include, but are not limited to, monomer units of ethylene glycol, 1,4-butanediol, and terephthalic acid.

The recycled PET or recycled PBT is not limited and can be selected as appropriate according to the intended purpose. For example, recycled products of the PET or PBT products, off-spec fiber waste, or pellets can be used. Among these, from the viewpoint of reducing the environmental impact, recycled products (hereinafter sometimes referred to as “recycled resin”) processed into a flake shape are preferable.

The molecular weight distribution, composition, manufacturing method, and form when used of PET or PBT, which serves as the raw material of the components derived from PET or PBT, are not limited, and may be selected as appropriate according to the intended purpose.

### <<Plant-Derived Component>>

The plant-derived component is not limited if the component is a plant-derived component, and can be selected as appropriate according to the intended purpose. For example, the plant-derived monomer may be used alone as a single type, or in a combination of two or more types.

The plant-derived monomer according to embodiments of the present disclosure is not limited and can be selected as appropriate according to the intended purpose, and examples include, but are not limited to, ethylene glycol, 1,3-propanediol, 1,3-butanediol, neopentyl glycol, adipic acid, terephthalic acid, phthalic acid, maleic acid, succinic acid, sebacic acid, dodecanedioic acid, abietic acid, and dehydroabietic acid.

### <Amorphous Polyester Resin>

As the amorphous polyester resin forming the core layer of the core-shell structure, the amorphous polyester resin A described below is preferable. Further, as the amorphous polyester resin contained in the shell of the resin particle, the amorphous polyester resin B described later is preferable.

### <<Amorphous Polyester Resin A>>

As the amorphous polyester resin A, a linear polyester resin is preferable, and an unmodified polyester resin is also preferable. The amorphous polyester resin A is a polyester resin soluble in tetrahydrofuran (THF) and chloroform.

The unmodified polyester resin is a polyester resin obtained by using a polyhydric alcohol and a polycarboxylic acid, other polycarboxylic acids, or derivatives thereof, and is a polyester resin that is not modified with a compound or the like. As the amorphous polyester resin A, a component derived from polyethylene terephthalate or polybutylene terephthalate, which are recycled resins, may be used. As a result of using the environmentally friendly component in at least either the polyhydric alcohol and the polycarboxylic acid or derivative thereof, the amorphous polyester resin A can be made into an environmentally friendly component.

### —Polyhydric Alcohol—

The polyhydric alcohol is not limited and can be selected as appropriate according to the intended purpose, and examples include, but are not limited to, diols.

Examples of the diol include, but are not limited to, alkylene (number of carbon atoms: 2 to 3) oxide adducts of bisphenol A (average number of moles added: 1 to 10), ethylene glycol, 1,3-propanediol, 1,3-butanediol, 1,4-butanediol, neopentyl glycol, hydrogenated bisphenol A, and alkylene (number of carbon atoms: 2 to 3) oxide adducts of hydrogenated bisphenol A (average number of moles added: 1 to 10).

Examples of the alkylene (number of carbon atoms: 2 to 3) oxide adduct of bisphenol A (average number of moles added: 1 to 10) include, but are not limited to, polyoxypropylene (2.2)-2,2-bis(4-hydroxyphenyl) propane and polyoxyethylene (2.2)-2,2-bis(4-hydroxyphenyl) propane.

These may be used alone as a single type, or in a combination of two or more types.

As the polyhydric alcohol, from the viewpoint that the environmental friendliness can be enhanced, it is preferable to include plant-derived ethylene glycol, plant-derived 1,3-propanediol, plant-derived 1,3-butanediol, plant-derived neopentyl glycol, recycled resin-derived ethylene glycol, or recycled resin-derived 1,4-butanediol.

Further, for the purpose of adjusting the acid value and hydroxyl value, the amorphous polyester resin A may contain a trihydric or higher alcohol at a terminal end of the resin chain.

Examples of the trihydric or higher alcohol include, but are not limited to, glycerin, pentaerythritol, or trimethylolpropane. The use of plant-derived glycerin is preferable in that the environmental friendliness can be enhanced.

—Component Derived from Polyethylene Terephthalate or Polybutylene Terephthalate—

The component derived from polyethylene terephthalate (PET) or polybutylene terephthalate (PBT) is not limited if the component is derived from PET or PBT, and can be selected as appropriate according to the intended purpose.

Hereinafter, “polyethylene terephthalate” is sometimes referred to as “PET”, and “polybutylene terephthalate” is sometimes referred to as “PBT”.

PET is generally composed of ethylene glycol and terephthalic acid. Furthermore, PBT is generally composed of butylene glycol and terephthalic acid. Therefore, examples of the component derived from PET or PBT include, but are not limited to, monomer units of ethylene glycol, butylene glycol, or terephthalic acid.

As the PET or PBT, using recycled PET or recycled PBT is preferable from the viewpoint of environmental friendliness.

The recycled PET or recycled PBT is not limited and can be selected as appropriate according to the intended purpose. For example, recycled products of the PET or PBT products, off-spec fiber waste, or pellets can be used. Among these, from the viewpoint of reducing the environmental impact, recycled products (hereinafter sometimes referred to as “recycled resin”) processed into a flake shape are preferable.

The molecular weight distribution, composition, manufacturing method, and form when used of PET or PBT, which serves as the raw material of the component derived from PET or PBT, are not limited, and may be selected as appropriate according to the intended purpose.

The weight average molecular weight (Mw) of the PET or PBT is not limited and can be selected as appropriate according to the intended purpose, but is preferably 30,000 to 100,000.

### —Polycarboxylic Acid or Derivative Thereof—

The polycarboxylic acid is not limited and can be selected as appropriate according to the intended purpose, and examples include, but are not limited to, dicarboxylic acids.

Examples of the dicarboxylic acid include, but are not limited to, adipic acid, phthalic acid, isophthalic acid, terephthalic acid, fumaric acid, maleic acid, succinic acid, sebacic acid, dodecanedioic acid, abietic acid, dehydroabietic acid, and succinic acid substituted with an alkyl group having 1 to 20 carbon atoms or an alkenyl group having 2 to 20 carbon atoms.

Examples of the succinic acid substituted with an alkyl group having 1 to 20 carbon atoms or an alkenyl group having 2 to 20 carbon atoms include, but are not limited to, dodecenylsuccinic acid or octylsuccinic acid.

The derivative of the polycarboxylic acid is not limited and can be selected as appropriate according to the intended purpose, and examples include, but are not limited to, polycarboxylic acid anhydrides and polycarboxylic acid esters.

These may be used alone as a single type, or in a combination of two or more types.

Among these, the polycarboxylic acid preferably contains plant-derived adipic acid, plant-derived terephthalic acid, plant-derived phthalic acid, plant-derived maleic acid, plant-derived succinic acid, plant-derived sebacic acid, plant-derived dodecanedioic acid, plant-derived abietic acid, plant-derived dehydroabietic acid, or recycled resin-derived terephthalic acid. As a result of using a polycarboxylic acid that is plant-derived or derived from recycled PET or recycled PBT, the environmental friendliness can be enhanced. In addition, as a polycarboxylic acid monomer, it is more preferable to include at least one biomass-derived dicarboxylic acid having 6 or more carbon atoms. When the number of carbon atoms is 6 or more, because the amount of environmentally friendly components can be increased without increasing the ester group concentration of the resin, both charging stability under high-temperature and high-humidity and environmental friendliness can be achieved.

Also, for the purpose of adjusting the chargeability and SP value, the amorphous polyester resin A may contain a polycarboxylic acid containing a sulfo group.

### —Polycarboxylic Acid Containing Sulfo Group—

The polycarboxylic acid containing a sulfo group contains a sulfo group and a salt thereof in the skeleton of a polycarboxylic acid that is copolymerizable as a polyester. Examples include, but are not limited to, 5-sulfoisophthalic acid, 2-sulfoisophthalic acid, 4-sulfoisophthalic acid, 4-sulfo-2,6-naphthalenedicarboxylic acid, sulfoterephthalic acid, and their ammonium salts, lithium salts, sodium salts, potassium salts, magnesium salts, calcium salts, copper salts, and iron salts.

These polycarboxylic acids containing a sulfo group may be used alone as a single type, or in combination of two or more. Among these, the sulfonate is preferably a 5-sulfoisophthalate, and 5-sulfoisophthalic acid sodium salt and 5-sulfoisophthalic acid potassium salt are particularly preferable.

The molar ratio of the polycarboxylic acid containing a sulfo group is not limited and can be selected as appropriate according to the intended purpose. However, the molar ratio is preferably 2 mol % to 10 mol %, and more preferably 2 mol % to 5 mol %, relative to the total amount of the carboxylic acid monomers constituting the polyester resin. When the molar ratio of the dicarboxylic acid containing a sulfo group is 2 mol % or more, the chargeability is excellent, and when the molar ratio of the monomer unit having a sulfo group in the polyester resin having a sulfo group is 10 mol % or less, the aggregation of the polyester aqueous dispersion increases, and the adhesion increases when used as the shell of the resin particle.

The molar ratio of the polycarboxylic acid containing a sulfo group can be measured by substituting the area of a chromatogram derived from a monomer having a sulfonate group obtained by pyrolysis gas chromatography (pyrolysis GC) into a calibration curve formula for the monomer having a sulfonate group.

The fact that the resin particle contains the sulfonate group-containing polyester resin can be confirmed, for example, by a method of measuring sulfur(S) intensity by trace element analysis using a fluorescent X-ray method, a method of quantifying a monomer having a sulfonate group by gas chromatograph-mass spectrometry (GC/MS), or a method of quantifying a sulfonate group on the outermost surface of the resin fine particle by time-of-flight secondary ion mass spectrometry (TOF-SIMS) to qualitatively analyze the resin structure of the outermost surface of the resin fine particle.

The molecular weight of the amorphous polyester resin A is not limited and can be selected as appropriate according to the intended purpose, but is preferably in the following ranges in a measurement by GPC.

The weight average molecular weight (Mw) of the amorphous polyester resin A is preferably 3,000 to 10,000, and more preferably 4,000 to 10,000.

The number average molecular weight (Mn) of the amorphous polyester resin A is preferably 1,000 to 4,000, and more preferably 1,500 to 3,000.

The molecular weight ratio (Mw/Mn) of the amorphous polyester resin A is preferably 1.0 to 4.0, and more preferably 1.0 to 3.5.

When the weight average molecular weight (Mw) and the number average molecular weight (Mn) of the amorphous polyester resin A are at or above the lower limit of the preferred ranges, it is possible to restrict a decrease in durability against stress such as heat resistant storage stability of the resin particle and stirring in a developing device. Furthermore, when the weight average molecular weight (Mw) and the number average molecular weight (Mn) of the amorphous polyester resin A are at or below the upper limit of the preferred ranges, it is possible to restrict an increase in viscoelasticity of the resin particle during melting and restrict a decrease in the low-temperature fixability.

The acid value of the amorphous polyester resin A is not limited and can be selected as appropriate according to the intended purpose, but is preferably 1 mgKOH/g to 50 mgKOH/g, and more preferably 5 mgKOH/g to 30 mgKOH/g. When the acid value of the amorphous polyester resin A is 1 mgKOH/g or more, the toner containing the resin particle easily becomes negatively charged, and furthermore, during fixing to a recording medium such as paper, the affinity between the recording medium and the toner is improved, and the low-temperature fixability can be enhanced. In addition, when the acid value of the amorphous polyester resin A is 50 mgKOH/g or less, it is possible to restrict a decrease in the charging stability, particularly the charging stability against environmental fluctuations.

The acid value of the amorphous polyester resin A can be measured in accordance with the measurement method described in Japanese Industrial Standard (JIS) K0070-1992.

The hydroxyl value of the amorphous polyester resin A is not limited and can be selected as appropriate according to the intended purpose, but is preferably 5 mgKOH/g or more. Furthermore, the upper limit of the hydroxyl value of the amorphous polyester resin A is not limited and can be selected as appropriate according to the intended purpose, but is preferably 30 mgKOH/g or less. The lower limit and upper limit of the hydroxyl value of the amorphous polyester resin A can be appropriately combined and are preferably 5 mgKOH/g to 30 mgKOH/g.

The hydroxyl value of the amorphous polyester resin A can be measured in accordance with the measurement method described in JIS K0070-1966.

When the amorphous polyester resin A is used as the core of the resin particle, the ratio (OHVa/AVa) of the hydroxyl value (OHVa) of the polyester resin A to the acid value (AVa) is preferably 1.1 to 1.5. If the ratio is lower than 1.1, the core is too stable and repels the shell, such that the shell does not adhere to the core. If the ratio exceeds 1.5, the aggregation of the shell material is too vigorous, and the cores aggregate with each other to become coarse.

The glass transition temperature (Tg) of the amorphous polyester resin A is not limited and can be selected as appropriate according to the intended purpose, but is preferably 40° C. or higher and 80° C. or lower, and more preferably 50° C. or higher and 70° C. or lower. When the glass transition temperature (Tg) of the amorphous polyester resin A is 40° C. or higher, the heat resistant storage stability of the toner containing the resin particle and durability against stress such as stirring in a developing device become sufficient, and the filming resistance is also improved. When the glass transition temperature (Tg) of the amorphous polyester resin A is 80° C. or lower, deformation by heating and pressurization during fixing of the toner containing the resin particle becomes sufficient, and the low-temperature fixability is improved.

The molecular structure of the amorphous polyester resin A can be confirmed by measurement methods using nuclear magnetic resonance spectroscopy (NMR) using a solution or solid, X-ray diffraction, gas chromatograph-mass spectrometry (GC/MS), liquid chromatograph analysis (LC/MS), or infrared absorption spectroscopy (IR). An example of such a method includes, but is not limited to, a method of detecting, as the amorphous polyester resin A, a resin that does not have absorption based on δCH (out-of-plane bending vibration) of an olefin at 965±10 cm⁻¹ and 990±10 cm⁻¹ in an infrared absorption spectrum obtained by IR.

The solubility parameter (hereinafter “SP value”, SPa) of the amorphous polyester resin A is not limited and can be selected as appropriate according to the intended purpose, but is preferably 10.8 or more and 11.4 or less, and more preferably 10.8 or more and 11.2 or less. When the SP value is 10.8 or more, compatibility between the amorphous polyester resin A and the crystalline polyester resin at room temperature can be restricted, such that the heat resistant storage stability of the resin particle is improved. When the SP value is 11.4 or less, the hydrophilicity becomes low, and the charging stability under high-temperature and high-humidity is improved.

The SP value (SPa) of the amorphous polyester resin A can be calculated by the following method.

The SP value is referred to as a solubility parameter (also referred to as a dissolution parameter or a solution parameter), and is a numerical representation of how easily substances dissolve in each other. The SP value is represented by the square root of the attractive force between molecules, that is, the cohesive energy density (CED). Note that the CED is the amount of energy required to evaporate 1 mL of a substance.

The calculation of the SP value (cal/cm³)^{1/2} in the present disclosure can be performed by the Fedors method using the following formula (I).

$$SP value ( solubility parameter ) = {( CED value )}^{1 / 2} = {( E / V )}^{1 / 2} \qquad ( I )$$

In formula (I), E is the molecular cohesive energy (cal/mol), Vis the molar volume (cm³/mol), and when the evaporation energy of the atomic group is Δei and the molar volume is Δvi, E and V are represented by the following formula (II) and formula (III), respectively.

$$E = Σ δ ei \qquad ( II )$$

$$V = Σ δ vi \qquad ( III )$$

There are various theories on the calculation method of the SP value, but in the present disclosure, the Fedors method that is generally used is used.

For the various data used in the present calculation method, namely the evaporation energy Δei and molar volume Δvi of each atomic group, the data listed in the document “Imoto, Minoru, Basic Theory of Gluing, Macromolecule Publication Meeting, pp. 89-103” is used.

The amount of the plant-derived component in the amorphous polyester resin A can be determined by measuring the radioactive carbon isotope ¹⁴C concentration using an accelerator mass spectrometer (AMS, manufactured by Beta Analytic). By substituting the measured ¹⁴C concentration into the following formula (4), the “plant-derived component ratio” in the resin particle can be calculated. It is desirable that the plant-derived component ratio is high from the viewpoint of carbon neutrality.

$$Plant - derived component ratio ( \% ) = {}^{14} C concentration ( pMC ) / 10 \; 7.5 \times 100 \qquad ( 4 )$$

The content of the amorphous polyester resin A is not limited and can be selected as appropriate according to the intended purpose, but is preferably 50 parts by mass or more and 90 parts by mass or less, and more preferably 60 parts by mass or more and 80 parts by mass or less, relative to 100 parts by mass of the resin particle. When the content of the amorphous polyester resin A is 50 parts by mass or more relative to 100 parts by mass of the resin particle, it is possible to restrict deterioration of the dispersibility of a pigment or a release agent in the resin particle and restrict the occurrence of fogging or disturbance of the image. Further, when the content of the amorphous polyester resin A is 90 parts by mass or less relative to 100 parts by mass of the resin particle, it is possible to prevent the content of the crystalline resin from becoming small and restrict a decrease in the low-temperature fixability.

When the content of the amorphous polyester resin A is within the more preferable range above, there is an advantage that both excellent high image quality and low-temperature fixability can be obtained.

### <<Amorphous Polyester Resin B>>

As the amorphous polyester resin B, a linear polyester resin is preferable, and an unmodified polyester resin is also preferable. The amorphous polyester resin B is a polyester resin soluble in tetrahydrofuran (THF) and chloroform.

The unmodified polyester resin is a polyester resin obtained by using a polyhydric alcohol and a polycarboxylic acid, other polycarboxylic acids, or derivatives thereof, and is a polyester resin that is not modified with a compound or the like. As the amorphous polyester resin B, a component derived from polyethylene terephthalate or polybutylene terephthalate, which are recycled resins, may be used. As a result of using the environmentally friendly component in at least either the polyhydric alcohol and the polycarboxylic acid or derivative thereof, the amorphous polyester resin B can be made into an environmentally friendly component, but the amount of the environmentally friendly component is preferably 0%. Because environmentally friendly components generally contain many short-chain aliphatic hydrocarbons, not using environmentally friendly components as monomers lowers the ester group concentration of the resin, increases hydrophilicity, and improves the charging stability under high-temperature and high-humidity conditions.

### —Polyhydric Alcohol—

The polyhydric alcohol is not limited and can be selected as appropriate according to the intended purpose, and examples include, but are not limited to, diols.

Examples of the diol include, but are not limited to, alkylene (number of carbon atoms: 2 to 3) oxide adducts of bisphenol A (average number of moles added: 1 to 10), ethylene glycol, 1,3-propanediol, 1,3-butanediol, 1,4-butanediol, neopentyl glycol, hydrogenated bisphenol A, and alkylene (number of carbon atoms: 2 to 3) oxide adducts of hydrogenated bisphenol A (average number of moles added: 1 to 10).

Examples of the alkylene (number of carbon atoms: 2 to 3) oxide adduct of bisphenol A (average number of moles added: 1 to 10) include, but are not limited to, polyoxypropylene (2.2)-2,2-bis(4-hydroxyphenyl) propane and polyoxyethylene (2.2)-2,2-bis(4-hydroxyphenyl) propane.

These may be used alone as a single type, or in a combination of two or more types.

Further, for the purpose of adjusting the acid value and hydroxyl value, the amorphous polyester resin B may contain a trihydric or higher alcohol at a terminal end of the resin chain.

Examples of the trihydric or higher alcohol include, but are not limited to, glycerin, pentaerythritol, or trimethylolpropane.

—Component Derived from Polyethylene Terephthalate or Polybutylene Terephthalate—

The component derived from polyethylene terephthalate (PET) or polybutylene terephthalate (PBT) is not limited if the component is derived from PET or PBT, and can be selected as appropriate according to the intended purpose.

Hereinafter, “polyethylene terephthalate” is sometimes referred to as “PET”, and “polybutylene terephthalate” is sometimes referred to as “PBT”.

PET is generally composed of ethylene glycol and terephthalic acid. Furthermore, PBT is generally composed of butylene glycol and terephthalic acid. Therefore, examples of the component derived from PET or PBT include, but are not limited to, monomer units of ethylene glycol, butylene glycol, or terephthalic acid.

The recycled PET or recycled PBT is not limited and can be selected as appropriate according to the intended purpose. For example, recycled products of the PET or PBT products, off-spec fiber waste, or pellets can be used. Among these, from the viewpoint of reducing the environmental impact, recycled products (hereinafter sometimes referred to as “recycled resin”) processed into a flake shape are preferable.

The molecular weight distribution, composition, manufacturing method, and form when used of PET or PBT, which serves as the raw material of the component derived from PET or PBT, are not limited, and may be selected as appropriate according to the intended purpose.

The weight average molecular weight (Mw) of the PET or PBT is not limited and can be selected as appropriate according to the intended purpose, but is preferably 30,000 to 100,000.

### —Polycarboxylic Acid or Derivative Thereof—

The polycarboxylic acid is not limited and can be selected as appropriate according to the intended purpose, and examples include, but are not limited to, dicarboxylic acids.

Examples of the dicarboxylic acid include, but are not limited to, adipic acid, phthalic acid, isophthalic acid, terephthalic acid, fumaric acid, maleic acid, succinic acid, sebacic acid, dodecanedioic acid, abietic acid, dehydroabietic acid, and succinic acid substituted with an alkyl group having 1 to 20 carbon atoms or an alkenyl group having 2 to 20 carbon atoms.

Examples of the succinic acid substituted with an alkyl group having 1 to 20 carbon atoms or an alkenyl group having 2 to 20 carbon atoms include, but are not limited to, dodecenylsuccinic acid or octylsuccinic acid.

The derivative of the polycarboxylic acid is not limited and can be selected as appropriate according to the intended purpose, and examples include, but are not limited to, polycarboxylic acid anhydrides and polycarboxylic acid esters.

These may be used alone as a single type, or in a combination of two or more types.

As the polycarboxylic acid, plant-derived adipic acid, plant-derived terephthalic acid, plant-derived phthalic acid, plant-derived maleic acid, plant-derived succinic acid, plant-derived sebacic acid, plant-derived dodecanedioic acid, plant-derived abietic acid, plant-derived dehydroabietic acid, or recycled resin-derived terephthalic acid may be used.

Also, for the purpose of adjusting the chargeability and SP value, the amorphous polyester resin B may contain a polycarboxylic acid containing a sulfo group.

### —Polycarboxylic Acid Containing Sulfo Group—

The polycarboxylic acid containing a sulfo group contains a sulfo group and a salt thereof in the skeleton of a polycarboxylic acid that is copolymerizable as a polyester. Examples include, but are not limited to, 5-sulfoisophthalic acid, 2-sulfoisophthalic acid, 4-sulfoisophthalic acid, 4-sulfo-2,6-naphthalenedicarboxylic acid, sulfoterephthalic acid, and their ammonium salts, lithium salts, sodium salts, potassium salts, magnesium salts, calcium salts, copper salts, and iron salts.

These polycarboxylic acids containing a sulfo group may be used alone as a single type, or in combination of two or more. Among these, the sulfonate is preferably a 5-sulfoisophthalate, and 5-sulfoisophthalic acid sodium salt and 5-sulfoisophthalic acid potassium salt are particularly preferable.

The molar ratio of the polycarboxylic acid containing a sulfo group is not limited and can be selected as appropriate according to the intended purpose. However, the molar ratio is preferably 2 mol % to 10 mol %, and more preferably 2 mol % to 5 mol %, relative to the total amount of the carboxylic acid monomers constituting the polyester resin. When the molar ratio of the dicarboxylic acid containing a sulfo group is 2 mol % or more, the chargeability is excellent, and when the molar ratio of the monomer unit having a sulfo group in the polyester resin having a sulfo group is 10 mol % or less, the aggregation of the polyester aqueous dispersion increases, and the adhesion increases when used as the shell of the resin particle.

The molar ratio of the polycarboxylic acid containing a sulfo group can be measured by substituting the area of a chromatogram derived from a monomer having a sulfonate group obtained by pyrolysis gas chromatography (pyrolysis GC) into a calibration curve formula for the monomer having a sulfonate group.

The fact that the resin particle contains the sulfonate group-containing polyester resin can be confirmed, for example, by a method of measuring sulfur(S) intensity by trace element analysis using a fluorescent X-ray method, a method of quantifying a monomer having a sulfonate group by gas chromatograph-mass spectrometry (GC/MS), or a method of quantifying a sulfonate group on the outermost surface of the resin fine particle by time-of-flight secondary ion mass spectrometry (TOF-SIMS) to qualitatively analyze the resin structure of the outermost surface of the resin fine particle.

The molecular weight of the amorphous polyester resin B is not limited and can be selected as appropriate according to the intended purpose, but is preferably in the following ranges in a measurement by GPC.

The weight average molecular weight (Mw) of the amorphous polyester resin B is preferably 5,000 to 15,000, and more preferably 10,000 to 15,000.

The number average molecular weight (Mn) of the amorphous polyester resin B is preferably 4,500 to 14,000, and more preferably 9,000 to 14,000.

The molecular weight ratio (Mw/Mn) of the amorphous polyester resin B is preferably 1.0 to 4.0, and more preferably 1.0 to 3.5.

When the weight average molecular weight (Mw) and the number average molecular weight (Mn) of the amorphous polyester resin B are at or above the lower limit of the preferred ranges, it is possible to restrict a decrease in durability against stress such as heat resistant storage stability of the resin particle and stirring in a developing device. Furthermore, when the weight average molecular weight (Mw) and the number average molecular weight (Mn) of the amorphous polyester resin B are at or below the upper limit of the preferred ranges, it is possible to restrict an increase in viscoelasticity of the resin particle during melting and restrict a decrease in low-temperature fixability.

The acid value of the amorphous polyester resin B is not limited and can be selected as appropriate according to the intended purpose, but is preferably 1 mgKOH/g to 50 mgKOH/g, and more preferably 5 mgKOH/g to 30 mgKOH/g. When the acid value of the amorphous polyester resin B is 1 mgKOH/g or more, the toner containing the resin particle easily becomes negatively charged, and furthermore, during fixing to a recording medium such as paper, the affinity between the recording medium and the toner is improved, and the low-temperature fixability can be enhanced. In addition, when the acid value of the amorphous polyester resin B is 50 mgKOH/g or less, it is possible to restrict a decrease in the charging stability, particularly the charging stability against environmental fluctuations.

The acid value of the amorphous polyester resin B can be measured in accordance with the measurement method described in JIS K0070-1992.

The hydroxyl value of the amorphous polyester resin B is not limited and can be selected as appropriate according to the intended purpose, but is preferably 5 mgKOH/g or more. Furthermore, the upper limit of the hydroxyl value of the amorphous polyester resin B is not limited and can be selected as appropriate according to the intended purpose, but is preferably 30 mgKOH/g or less. The lower limit and upper limit of the hydroxyl value of the amorphous polyester resin B can be appropriately combined and are preferably 5 mgKOH/g to 30 mgKOH/g.

The hydroxyl value of the amorphous polyester resin B can be measured in accordance with the measurement method described in JIS K0070-1966.

When the amorphous polyester resin B is used as the core of the resin particle, the ratio (OHVa/AVa) of the hydroxyl value (OHVa) of the polyester resin A to the acid value (AVa) is preferably 1.1 to 1.5. If the ratio is lower than 1.1, the core is too stable and repels the shell, such that the shell does not adhere to the core. If the ratio exceeds 1.5, the aggregation of the shell material is too vigorous, and the cores aggregate with each other to become coarse.

The glass transition temperature (Tg) of the amorphous polyester resin A is not limited and can be selected as appropriate according to the intended purpose, but is preferably 50° C. or higher and 80° C. or lower, and more preferably 50° C. or higher and 70° C. or lower. When the glass transition temperature (Tg) of the amorphous polyester resin A is 50° C. or higher, the heat resistant storage stability of the toner containing the resin particle and durability against stress such as stirring in a developing device become sufficient, and the filming resistance is also improved. When the glass transition temperature (Tg) of the amorphous polyester resin B is 80° C. or lower, deformation by heating and pressurization during fixing of the toner containing the resin particle becomes sufficient, and the low-temperature fixability is improved.

The molecular structure of the amorphous polyester resin B can be confirmed by measurement methods using nuclear magnetic resonance spectroscopy (NMR) using a solution or solid, X-ray diffraction, gas chromatograph-mass spectrometry (GC/MS), liquid chromatograph analysis (LC/MS), or infrared absorption spectroscopy (IR). Among these, an example of such a method includes, but is not limited to, a method of detecting, as the amorphous polyester resin B, a resin that does not have absorption based on δCH (out-of-plane bending vibration) of an olefin at 965±10 cm⁻¹ and 990±10 cm⁻¹ in an infrared absorption spectrum obtained by IR.

The SP value (solubility parameter, SPb) of the amorphous polyester resin B is not limited and can be selected as appropriate according to the intended purpose, but is preferably 11.6 or less, and more preferably 11.0 or more and 11.6 or less. When the SP value is 11.0 or more, compatibility between the amorphous polyester resin B and the crystalline polyester resin at room temperature can be restricted, such that the heat resistant storage stability of the resin particle is improved. Furthermore, when the SP value is 11.6 or less, the hydrophilicity becomes low, and the charging stability under high-temperature and high-humidity is improved.

The SP value (SPb) of the amorphous polyester resin B can be calculated by the following method.

The SP value is referred to as a solubility parameter (also referred to as a dissolution parameter or a solution parameter), and is a numerical representation of how easily substances dissolve in each other. The SP value is represented by the square root of the attractive force between molecules, that is, the cohesive energy density (CED). Note that the CED is the amount of energy required to evaporate 1 mL of a substance.

The calculation of the SP value (cal/cm³)^{1/2} in the present disclosure can be performed by the Fedors method using the following formula (I).

$$SP value ( solubility parameter ) = {( CED value )}^{1 / 2} = {( E / V )}^{1 / 2} \qquad ( I )$$

In formula (I), E is the molecular cohesive energy (cal/mol), Vis the molar volume (cm³/mol), and when the evaporation energy of the atomic group is Δei and the molar volume is Δvi, E and V are represented by the following formula (II) and formula (III), respectively.

$$E = Σ δ ei \qquad ( II )$$

$$V = Σ δ vi \qquad ( III )$$

There are various theories on the calculation method of the SP value, but in the present disclosure, the Fedors method that is generally used is used.

For the various data used in the present calculation method, namely the evaporation energy Δei and molar volume Δvi of each atomic group, the data listed in the document “Imoto, Minoru, Basic Theory of Gluing, Macromolecule Publication Meeting, pp. 89-103” is used.

The amount of the plant-derived component in the amorphous polyester resin B can be determined by measuring the radioactive carbon isotope ¹⁴C concentration using an accelerator mass spectrometer (AMS, manufactured by Beta Analytic). By substituting the measured ¹⁴C concentration into the following formula (4), the “plant-derived component ratio” in the resin particle can be calculated. It is desirable that the plant-derived component ratio is high from the viewpoint of carbon neutrality.

Plant-derived component ratio (%)=¹⁴C concentration (pMC)/107.5×100 (4)

The content of polyester resin B in the resin particle is not limited and can be selected as appropriate according to the intended purpose, but is preferably 5% by mass to 40% by mass and more preferably 10% by mass to 40% by mass relative to the total mass of the resin fine particle. When the content of the sulfonate group-containing polyester resin is 5% by mass or more, a sufficient effect on the heat resistant storage stability is obtained.

### <Crystalline Resin>

As the crystalline resin, a crystalline polyester resin is used, but other crystalline resins may be used together with the crystalline polyester resin. The other crystalline resins are not limited as long as they have crystallinity and can be selected as appropriate according to the intended purpose, and examples include, but are not limited to, polyurethane resins, polyurea resins, polyamide resins, polyether resins, vinyl resins, and modified crystalline resins. One such crystalline polyester resin may be used in combination with the crystalline polyester resin, or two or more may be used together.

### <<Crystalline Polyester Resin>>

Because the crystalline polyester resin (hereinafter sometimes referred to as “crystalline polyester resin C”) has a high crystallinity, the crystalline polyester resin exhibits hot-melt characteristics where the viscosity changes sharply near the fixing start temperature. The crystalline polyester resin C is a polyester resin insoluble in tetrahydrofuran (THF) and soluble in chloroform.

As a result of using the crystalline polyester resin C having such characteristics together with the amorphous polyester resin, a resin particle having both good heat resistant storage stability and low-temperature fixability can be obtained. For example, by using the crystalline polyester resin C and the amorphous polyester resin in combination, good heat resistant storage stability can be obtained due to the crystallinity of the crystalline polyester resin C until just before the melting start temperature. Further, at the melting start temperature, the viscosity drops sharply due to the melting of the crystalline polyester resin C (sharp-melt property). Consequently, the crystalline polyester resin C becomes compatible with the amorphous polyester resin B, leading to a sharp decrease in viscosity, which leads to good fixing. Moreover, good results are also observed in terms of the release width (difference between the minimum fixing temperature and the temperature at which high-temperature offset resistance occurs).

The crystalline polyester resin C is obtained using a polyhydric alcohol and a polycarboxylic acid or a derivative thereof. The crystalline resin can be made into an environmentally friendly component by using a plant-derived component or a component derived from recycled PET or recycled PBT in at least one of the polyhydric alcohol and the polycarboxylic acid or derivative thereof.

These may be used alone as a single type, or in a combination of two or more types.

The derivative of the polycarboxylic acid is not limited and can be selected as appropriate according to the intended purpose, and examples include, but are not limited to, polycarboxylic acid anhydrides and polycarboxylic acid esters.

Note that, herein, as described above, the crystalline polyester resin C refers to a resin obtained using the polyhydric alcohol and the polycarboxylic acid or derivative thereof, and resins obtained by modifying a polyester resin, such as the prepolymer and resins obtained by subjecting the prepolymer to at least one of a crosslinking reaction and an elongation reaction, are not classified as the crystalline polyester resin C.

### —Polyhydric Alcohol—

The polyhydric alcohol is not limited and can be selected as appropriate according to the intended purpose, and examples include, but are not limited to, diols and trihydric or higher alcohols.

Examples of the diol include, but are not limited to, saturated aliphatic diols.

Examples of the saturated aliphatic diol include, but are not limited to, linear saturated aliphatic diols and branched saturated aliphatic diols.

Specific examples of the saturated aliphatic diol include, but are not limited to, ethylene glycol, 1,3-propanediol, 1,3-butanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, or 1,14-eicosandecanediol. These may be used alone as a single type, or in a combination of two or more types. Among these, ethylene glycol, butylene glycol, 1,4-butanediol, 1,6-hexanediol, 1,8-octanediol, 1,10-decanediol, or 1,12-dodecanediol are preferable in that the crystalline polyester resin C has high crystallinity and excellent sharp-melt properties.

As the polyhydric alcohol, plant-derived polyhydric alcohols are preferable in that the environmental friendliness can be enhanced.

Examples of the trihydric or higher alcohol include, but are not limited to, glycerin, trimethylolethane, trimethylolpropane, and pentaerythritol.

These polyhydric alcohols may be used alone as a single type, or in a combination of two or more types.

### —Polycarboxylic Acid—

The polycarboxylic acid is not limited and can be selected as appropriate according to the intended purpose, and examples include, but are not limited to, dicarboxylic acids.

Examples of the dicarboxylic acid include, but are not limited to, saturated aliphatic dicarboxylic acids, unsaturated aliphatic dicarboxylic acids, and aromatic dicarboxylic acids.

Examples of the saturated aliphatic dicarboxylic acid include, but are not limited to, oxalic acid, malonic acid, succinic acid, glutaric acid, sebacic acid, adipic acid, and dodecanedioic acid.

Examples of the unsaturated aliphatic dicarboxylic acid include, but are not limited to, fumaric acid and maleic acid.

Examples of the aromatic dicarboxylic acid include, but are not limited to, terephthalic acid.

These may be used alone as a single type, or in a combination of two or more types.

The dicarboxylic acid is preferably a plant-derived saturated aliphatic having 4 to 12 carbon atoms. As a result of the dicarboxylic acid being plant-derived, the environmental friendliness can be enhanced.

The melting point of the crystalline polyester resin C is not limited and can be selected as appropriate according to the intended purpose, but is preferably 60° C. or higher and 80° C. or lower. When the melting point of the crystalline polyester resin C is 60° C. or higher, it is possible to prevent the crystalline polyester resin C from melting at low temperatures and causing a decrease in the heat resistant storage stability of the resin particle. When the melting point of the crystalline polyester resin C is 80° C. or lower, the melting of the crystalline polyester resin C during heating at the time of fixing can be improved, restricting a decrease in the low-temperature fixability.

The molecular weight of the crystalline polyester resin C is not limited and can be selected as appropriate according to the intended purpose. From the viewpoint that a resin having a sharp molecular weight distribution and low molecular weight has excellent low-temperature fixability, and a resin having many high molecular weight components has improved heat resistant storage stability, the following ranges are preferable for the ortho-dichlorobenzene soluble part of the crystalline polyester resin C as measured by GPC.

The weight average molecular weight (Mw) of the crystalline polyester resin C is preferably 3,000 to 30,000, and more preferably 5,000 to 25,000.

The number average molecular weight (Mn) of the crystalline polyester resin C is preferably 1,000 to 10,000, and more preferably 2,000 to 10,000.

The molecular weight ratio (Mw/Mn) of the crystalline polyester resin C is preferably 1.0 to 10, and more preferably 1.0 to 5.0.

The acid value of the crystalline polyester resin C is not limited and can be selected as appropriate according to the intended purpose. However, from the viewpoint of affinity between the recording medium and the resin particle, in order to achieve the desired low-temperature fixability, the lower limit of the acid value is preferably 5 mgKOH/g or more, and more preferably 10 mgKOH/g or more. Furthermore, to improve the high-temperature offset resistance, the upper limit of the acid value of crystalline polyester resin C is preferably 45 mgKOH/g or less.

The acid value of the crystalline polyester resin C can be measured in accordance with the measurement method described in JIS K0070-1992.

The hydroxyl value of the crystalline polyester resin C is not limited and can be selected as appropriate according to the intended purpose. However, to achieve the desired low-temperature fixability and good charging characteristics, the hydroxyl value is preferably 0 mgKOH/g to 50 mgKOH/g, and more preferably 0 mgKOH/g to 10 mgKOH/g.

The hydroxyl value of the crystalline polyester resin C can be measured in accordance with the measurement method described in JIS K0070-1966.

The molecular structure of the crystalline polyester resin C can be confirmed by measurement methods using nuclear magnetic resonance spectroscopy (NMR) using a solution or solid, X-ray diffraction, gas chromatograph-mass spectrometry (GC/MS), liquid chromatograph analysis (LC/MS), or infrared absorption spectroscopy (IR). Among these, a method of detecting, as the crystalline polyester resin C, a resin that has absorption based on δCH (out-of-plane bending vibration) of an olefin at 965±10 cm⁻¹ and 990±10 cm⁻¹ in an infrared absorption spectrum obtained by IR is simple.

The SP value (solubility parameter, SPc) of the crystalline polyester resin C is not limited and can be selected as appropriate according to the intended purpose, but is more preferably 9.5 or more and 10.4 or less. As a result of the SP value being 9.5 or more, compatibility at room temperature between the amorphous polyester resin B and the crystalline polyester C can be restricted, such that the hydrophilicity becomes low and charging stability under high-temperature and high-humidity conditions improves. In addition, as a result of the SP value being 10.4 or less, compatibility between the crystalline polyester C and the amorphous polyester resin B is restricted, which improves the heat resistant storage stability.

The SP value (SPc) of the crystalline polyester resin C can be calculated by the following method.

The SP value is referred to as a solubility parameter (also referred to as a dissolution parameter or a solution parameter), and is a numerical representation of how easily substances dissolve in each other. The SP value is represented by the square root of the attractive force between molecules, that is, the cohesive energy density (CED). Note that the CED is the amount of energy required to evaporate 1 mL of a substance.

The calculation of the SP value (cal/cm³)^{1/2} in the present disclosure can be performed by the Fedors method using the following formula (I).

$$SP value ( solubility parameter ) = {( CED value )}^{1 / 2} = {( E / V )}^{1 / 2} \qquad ( I )$$

In formula (I), E is the molecular cohesive energy (cal/mol), Vis the molar volume (cm³/mol), and when the evaporation energy of the atomic group is Δei and the molar volume is Δvi, E and V are represented by the following formula (II) and formula (III), respectively.

$$E = Σ δ ei \qquad ( II )$$

$$V = Σ δ vi \qquad ( III )$$

There are various theories on the calculation method of the SP value, but in the present disclosure, the Fedors method that is generally used is used.

For the various data used in the present calculation method, namely the evaporation energy Δei and molar volume Δvi of each atomic group, the data listed in the document “Imoto, Minoru, Basic Theory of Gluing, Macromolecule Publication Meeting, pp. 89-103” is used.

The content of the crystalline polyester resin C in the resin particle is not limited and can be selected as appropriate according to the intended purpose, but is preferably 3 parts by mass or more and 20 parts by mass or less, and more preferably 5 parts by mass or more and 15 parts by mass or less, relative to 100 parts by mass of the resin particle. When the content of the crystalline polyester resin C in the resin particle is 3 parts by mass or more, the sharp melting of the crystalline polyester resin C can be improved, and the low-temperature fixability can be improved. In addition, when the content of the crystalline polyester resin C in the resin particle is 20 parts by mass or less, a decrease in heat resistant storage stability can be restricted, and the occurrence of image fogging can be restricted. When the content of the crystalline polyester resin C is within the more preferable range above, there is an advantage that both excellent high image quality and low-temperature fixability can be obtained.

### <<Core-Shell Structure>>

The resin particle preferably has a core-shell structure. As the shell resin forming the shell layer, the amorphous polyester resin B is preferable, and as the amorphous polyester contained in the core, the amorphous polyester resin A is preferable.

Herein, “having a core-shell structure” refers to a structure having a core layer and a shell layer, where “shell layer” refers to a layer made of resin existing on the outermost layer of the resin particle, and “core layer” refers to a region inside the resin particle excluding the shell layer.

The core layer and the shell layer are not completely compatible with each other and are formed heterogeneously.

In the core-shell structure, the surface of the core layer is preferably covered with the shell layer.

In the core-shell structure, the surface of the core layer may be completely covered by the shell layer, or may not be completely covered by the shell layer. Examples of a mode in which the surface of the core layer is not completely covered with the shell layer include, but are not limited to, a mode in which the core layer is covered with the shell layer in a mesh-like pattern, and a mode in which the core layer is partially exposed from the shell layer. Among these, from the viewpoint of the filming resistance, it is preferable that the surface of the core layer is completely covered by the shell layer.

### —Shell Material—

The amorphous polyester resin B is used as a shell material. As mentioned above, examples of the amorphous polyester resin A include, but are not limited to, resins obtained by polycondensation of a polyhydric alcohol and a polycarboxylic acid, and contains the environmentally friendly component. The shell resin is preferably a resin containing the plant-derived resin.

Examples of methods of measuring the volume average particle size of the amorphous polyester in the polyester aqueous dispersion include, but are not limited to, a method using a Nanotrac particle size distribution measurement device (UPA-EX150, manufactured by Nikkiso Co., Ltd., dynamic light scattering method/laser doppler method).

First, a background measurement is performed beforehand with only the dispersion solvent of each target sample dispersion liquid. Then, the volume average particle size can be measured as a result of performing a measurement of the dispersion liquid in which each target sample is dispersed after adjustment to a measurement concentration range.

There are no particular limitations on the method of confirming the composition of the shell layer, and the method can be selected as appropriate according to the intended purpose. Examples of the method include, but are not limited to, a method of confirmation by surface layer (shell layer) composition analysis using nano IR (also referred to as “AMF-IR”).

Through an analysis method of nano IR, which combines an atomic force microscope (AFM) and IR to achieve nanoscale resolution, the composition can be obtained by acquiring the IR spectrum of the surface layer (shell layer) of the resin particle.

Specifically, after embedding the resin particle in an epoxy resin (S-31, manufactured by DEVCON) and curing the epoxy resin, a cross-section is prepared with a knife, and an ultrathin section of the resin particle with a thickness of 60 nm is cut using an ultrasonic ultramicrotome (Leica EM UC7, manufactured by Leica).

The prepared ultrathin section of the toner is collected on a substrate (ZnS), and the measurement point (shell layer) is measured by the AFM-IR method using a nanoscale infrared spectroscopic analysis system (for example, nanoIR2, manufactured by Anasys Instruments). The measurement range is from 1,900 cm⁻¹ to 910 cm⁻¹ with a resolution of 2 cm⁻¹, and the chemical structure of the measurement point (shell layer) can be analyzed from the obtained AFM-IR absorption spectrum. Therefore, the composition of the surface layer (shell layer) can be confirmed by such an analysis.

Note that the chemical structure of the core layer can also be analyzed by setting the measurement point to the core layer.

The average thickness of the shell layer is not limited and can be selected as appropriate according to the intended purpose, but is preferably 50 nm to 500 nm, and more preferably 100 nm to 200 nm.

When the average thickness of the shell layer is 50 nm or more, the core layer inside the resin particle can be protected and the mechanical strength resistance can be improved. When the average thickness of the shell layer is 200 nm or less, sufficient mechanical strength resistance can be maintained without hindering the low-temperature fixability.

Note that, herein, the “average thickness of the shell layer” refers to the thickness obtained by arbitrarily selecting 50 resin particles from particles within ±2.0 μm of the weight average particle diameter of the resin particles, measuring the thickness of each shell layer by the method described later, and averaging the thicknesses of the shell layers of the 50 resin particles.

The coverage of the core layer surface by the shell layer is not limited and can be selected as appropriate according to the intended purpose, but is preferably 50% to 100%, and more preferably 80% to 100%. Note that a coverage of 100% means that the entire surface of the core layer of the resin particle is covered by the shell layer.

The coverage (%) of the core layer surface by the shell layer can be calculated by the following formula (IV).

$$Coverage ( \% ) = ( Area of covered region ) / ( Total surface area of resin particle ) \times 100 \qquad ( IV )$$

In formula (IV), “total surface area of resin particles” represents the sum of the area of the covered region and the exposed area of the core layer, “area of covered region” represents the area of the region where the core layer is covered by the shell layer out of the total surface area of the resin particle, and “exposed area of the core layer” represents the area of the region where the core layer is not covered by the shell layer out of the total surface area of the resin particle.

The method of confirming that the resin particle has a core-shell structure is not limited and can be selected as appropriate according to the intended purpose. For example, after embedding the resin particle in an epoxy resin (S-31, manufactured by DEVCON) and curing the epoxy resin, a cross-section is prepared with a knife, and an ultrathin section of the resin particle with a thickness of 60 nm is cut using an ultrasonic ultramicrotome (Leica EM UC7, manufactured by Leica). The ultrathin section of the prepared toner is exposed to ruthenium tetroxide (RuO₄) gas to stain and distinguish the shell and core. The gas exposure time can be adjusted as appropriate according to the contrast during observation. Thereafter, the core-shell structure can be confirmed by observing a cross-sectional image of the resin particle using a transmission electron microscope (H-7500, manufactured by Hitachi High-Tech Corporation) at an acceleration voltage of 120 kV.

Furthermore, in the TEM image observed by the method described above, the covered region of the core layer (region where the core layer is covered by the shell layer in the resin particle) and the exposed region of the core layer (region where the core layer is not covered by the shell layer in the resin particle) on the surface of the resin particle can be distinguished by a difference in brightness values. Therefore, the TEM image observed by the method described above is subjected to binarization processing using image processing software, and the shell layer can be identified and the thickness of the shell layer can be measured based on the contrast ratio.

Image-J can be used as the image processing software. The method of calculating the average thickness of the shell layer using Image-J is as follows.
(1) Draw a straight line tracing the scale using Straight Line. Set the actual length and unit with Set Scale under Analyze.
(2) Enclose the outer periphery of a single resin particle in the cross-sectional image with Freehand-sections to create “Region 1”.
(3) Enclose the outer periphery of the region excluding the shell layer in the cross-sectional image of the single resin particle (that is, the boundary between the shell layer and the core layer) using Freehand-sections to create “Region 2”.
(4) Determine the weight center of “Region 1” using Analyze.
(5) Using an independently developed plugin, draw straight lines toward the weight center of the resin particle determined in (4) from coordinates obtained by dividing the outer periphery of “Region 1”, that is, the line surrounding the outer periphery of the single resin particle in (2) with Freehand-sections, into 100 equal intervals.
(6) Calculate the length obtained by subtracting the length passing through “Region 2” from the length passing through “Region 1” for each of the 100 straight lines created in (5), using the straight line tracing the scale created in (1), and take the average of the 100 lengths as the thickness of the shell layer of the single resin particle.
(7) Perform the operations of (2) to (6) for 50 resin particles, and calculate the average value of the thickness of the shell layer of the 50 resin particles. The average value is taken as the average thickness of the shell layer in the present disclosure.

The method of calculating the coverage by the shell layer using Image-J is as follows.
(1) Trace the section covered by the shell layer on the outer periphery of a single resin particle in the cross-sectional image of the resin particle with Freehand Line, and measure the length of the traced line using Analyze. This length is referred to as “Length 1”.
(2) Trace the entire outer periphery of the single resin particle in the cross-sectional image of the resin particle with Freehand Line, and measure the length of the traced line using “Analyze”. This length is referred to as “Length 2”.
(3) Calculate Length 1/Length 2×100, and take the value as the coverage by the shell layer for the single resin particle.
(4) Perform the operations of (1) to (3) for 50 resin particles, and calculate the average value of the coverage of the shell layer of the 50 resin particles. This average value is taken as the coverage of the shell layer in the present disclosure.

The SP value (SPa) of the amorphous polyester resin A and the SP value (SPc) of the crystalline polyester resin C preferably satisfy the following relational expression (1).

When (SPa−SPc) is 1.6 or less, the compatibility between the amorphous polyester resin A and the crystalline polyester resin C increases during fixing, which improves the low-temperature fixability.

$$Spa - Spc \leq 1.6 \qquad ( 1 )$$

The SP value (SPa) of the amorphous polyester resin A and the SP value (SPb) of the amorphous polyester resin B preferably satisfy the following relational expression (2). When (SPb−SPa) is 0.2 or more, the amorphous polyester B can form a layered shell layer around the core, which improves the heat resistant storage stability.

$$0.2 \leq SPb - SPa \qquad ( 2 )$$

### <Other Components>

The other components in the resin particle are not limited and can be selected as appropriate according to the intended purpose, and examples include, but are not limited to, colorants, release agents, charge control agents, fluidity improvers, cleanability improvers, magnetic materials, and shape-modifying agents. These may be used alone as a single type, or in a combination of two or more types.

### <<Colorant>>

The colorant is not limited and can be selected as appropriate according to the intended purpose, and examples include, but are not limited to, carbon black, nigrosine dye, iron black, naphthol yellow S, Hansa yellow (10G, 5G, G), cadmium yellow, yellow iron oxide, ocher, yellow lead, titanium yellow, polyazo yellow, Oil Yellow, Hansa yellow (GR, A, RN, R), Pigment Yellow L, benzidine yellow (G, GR), permanent yellow (NCG), Vulcan Fast Yellow (5G, R), Tartrazine Lake, Quinoline Yellow Lake, Anthrazane Yellow BGL, Isoindolinone Yellow, red iron oxide, red lead, lead red, cadmium red, cadmium mercury red, antimony vermilion, permanent red 4R, Para Red, Faise Red, parachlor orthonitro aniline red, Resol Fast Scarlet G, Brilliant Fast Scarlet, Brilliant Carmine BS, permanent red (F2R, F4R, FRL, FRLL, F4RH), Fast Scarlet VD, Vulcan Fast Rubin B, Brilliant Scarlet G, Lithol Rubin GX, permanent red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS, BC), Indigo, ultramarine, dark blue, Anthraquinone Blue, Fast Violet B, Methyl Violet Lake, cobalt purple, manganese purple, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These may be used alone as a single type, or in a combination of two or more types.

The content of the colorant in the resin particle is not limited and can be selected as appropriate according to the intended purpose, but is preferably 1 part by mass to 15 parts by mass, and more preferably 3 parts by mass to 10 parts by mass, relative to 100 parts by mass of the resin particle.

The colorant can also be used as a masterbatch combined with a resin.

The resin manufactured as the masterbatch or kneaded with the masterbatch is not limited and can be selected as appropriate according to the intended purpose, and examples include, but are not limited to, in addition to the amorphous polyester resin, polymers of styrene or substituted styrenes, styrene-based copolymers, polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin, and paraffin wax. These may be used alone as a single type, or in a combination of two or more types.

Examples of the polymers of styrene or substituted styrenes include, but are not limited to, polystyrene, poly-p-chlorostyrene, and polyvinyltoluene.

Examples of the styrene-based copolymers include, but are not limited to, styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-chloromethyl methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers.

The method of manufacturing the masterbatch is not limited and can be selected as appropriate according to the intended purpose, and examples include, but are not limited to, a method of mixing and kneading the resin of the masterbatch and the colorant by applying a high shear force. At this time, an organic solvent can be used to enhance the interaction between the colorant and the resin. Also, a so-called flushing method, in which an aqueous paste containing water of the colorant is mixed and kneaded with a resin and an organic solvent to transfer the colorant to the resin side, followed by removal of the water and organic solvent components, is preferably used because the wet cake of the colorant can be used as is without being dried. For the mixing and kneading, a high-shear dispersion device such as a three-roll mill is preferably used.

### <<Release Agent>>

The release agent is not limited and can be selected as appropriate from among known release agents, and examples include, but are not limited to, waxes, fatty acid amides, homopolymers or copolymers of polyacrylate, and crystalline polymers having long alkyl groups in a side chain. These may be used alone as a single type, or in a combination of two or more types. Note that the release agents above are soluble in chloroform.

Examples of the waxes include, but are not limited to, natural waxes, synthetic hydrocarbon waxes, and synthetic waxes.

Examples of natural waxes include, but are not limited to, vegetable waxes, animal waxes, mineral waxes, and petroleum waxes.

Examples of vegetable waxes include, but are not limited to, carnauba wax, cotton waxes, and wood waxes.

Examples of animal waxes include, but are not limited to, beeswax and lanolin.

Examples of mineral waxes include, but are not limited to, ozokerite and ceresin.

Examples of petroleum waxes include, but are not limited to, paraffin, microcrystalline, and petrolatum.

Examples of synthetic hydrocarbon waxes include, but are not limited to, Fischer-Tropsch wax and polyethylene wax.

Examples of synthetic waxes include, but are not limited to, esters, ketones, and ethers.

Examples of fatty acid amides include, but are not limited to, 12-hydroxystearic acid amide, stearic acid amide, phthalic anhydride imide, and chlorinated hydrocarbons.

Examples of the polyacrylate include, but are not limited to, low-molecular-weight crystalline polymer resins such as poly-n-stearyl methacrylate and poly-n-lauryl methacrylate.

Examples of the polyacrylate homopolymer or copolymer include, but are not limited to, n-stearyl acrylate-ethyl methacrylate copolymers.

Among these, as the release agent, vegetable-based waxes and ester waxes using plant-derived materials are preferred. The environmental friendliness can be enhanced as a result of the release agent being plant-derived.

The melting point of the release agent is not limited and can be selected as appropriate according to the intended purpose, but is preferably 60° C. or higher and 80° C. or lower. When the melting point of the release agent is 60° C. or higher, melting of the release agent at low temperatures can be restricted, and a decrease in the heat resistant storage stability can be restricted. Further, when the melting point of the release agent is 80° C. or lower, the occurrence of fixing offset due to insufficient melting of the release agent when the resin is melted in the fixing temperature range can be restricted, which enables image defects to be restricted.

The content of the release agent in the resin particle is not limited and can be selected as appropriate according to the intended purpose, but is preferably 2 parts by mass to 10 parts by mass, and more preferably 3 parts by mass to 8 parts by mass, relative to 100 parts by mass of the resin particle. When the content of the release agent is 2 parts by mass or more, a decrease in the high-temperature offset resistance and low-temperature fixability during fixing can be restricted. When the content of the release agent is 10 parts by mass or less, a decrease in the heat resistant storage stability and the occurrence of image fogging or the like can be restricted. When the content of the release agent is within the more preferable range, an advantage is obtained in terms of achieving high image quality and improving fixing stability.

### <<Charge Control Agent>>

The charge control agent is not limited and can be selected as appropriate according to the intended purpose, and examples include, but are not limited to, nigrosine-based dyes, triphenylmethane-based dyes, chromium-containing metal complex dyes, molybdic acid chelate pigments, rhodamine-based dyes, alkoxy-based amines, quaternary ammonium salts (including fluorine-modified quaternary ammonium salts), alkylamides, simple phosphorus or compounds thereof, simple tungsten or compounds thereof, fluorine-based activators, metal salts of salicylic acid, metal salts of salicylic acid derivatives, metal salts of oxynaphthoic acid, phenol-based condensates, azo-based pigments, boron complexes, and polymer-based compounds having functional groups (such as sulfonic acid groups, carboxyl groups, or quaternary ammonium salts). These may be used alone as a single type, or in a combination of two or more types.

The toner according to embodiments of the present disclosure may be positively chargeable or negatively chargeable, but is preferably negatively chargeable.

Specific examples of the charge control agent include, but are not limited to, nigrosine-based dye BONTRON 03, quaternary ammonium salt BONTRON P-51, metal-containing azo dye BONTRON S-34, oxynaphthoic acid-based metal complex E-82, salicylic acid-based metal complex E-84, phenol-based condensate E-89 (all manufactured by Orient Chemical Industries Co., Ltd.), quaternary ammonium salt molybdenum complexes TP-302 and TP-415 (all manufactured by Hodogaya Chemical Co., Ltd.), LRA-901, boron complex LR-147 (all manufactured by Japan Carlit Co., Ltd.), copper phthalocyanine, perylene, quinacridone, and azo-based pigments.

The content of the charge control agent is not limited and can be selected as appropriate according to the intended purpose, but is preferably 0.1 part by mass to 10 parts by mass, and more preferably 0.2 parts by mass to 5 parts by mass, relative to 100 parts by mass of the resin particle. When the content of the charge control agent is 10 parts by mass or less relative to 100 parts by mass of the resin particle, the chargeability of the toner containing the resin particle can be prevented from becoming excessively high, the effect of the charge control agent can be maintained, an increase in electrostatic attraction with a developing roller can be prevented, and a decrease in the fluidity of the developer and a decrease in the image density can be restricted. The charge control agents above can be dissolved and dispersed after being melt-kneaded with a masterbatch and a resin, can of course be added during direct dissolution and dispersion in an organic solvent, or may be fixed onto the surface of the resin particle after the production of the resin particle.

### <<Fluidity Improver>>

The fluidity improver is not limited as long as the fluidity improver can perform surface treatment to increase hydrophobicity and prevent deterioration of the fluidity characteristics and charging characteristics even under high humidity, and can be selected as appropriate according to the intended purpose. Examples of the fluidity improver include silane coupling agents, silylating agents, silane coupling agents having a fluoroalkyl group, organic titanate-based coupling agents, aluminum-based coupling agents, silicone oil, and modified silicone oil. These may be used alone as a single type, or in a combination of two or more types.

The content of the fluidity improver is not limited and can be selected as appropriate according to the intended purpose, but is preferably 0.01 parts by mass to 5.00 parts by mass, and more preferably 0.10 parts by mass to 2.00 parts by mass, relative to 100 parts by mass of the resin particle.

### <<Cleanability Improver>>

The cleanability improver is used for removing developer remaining on a photoconductor or primary transfer medium after transfer.

The cleanability improver is not limited and can be selected as appropriate according to the intended purpose, and examples include, but are not limited to, fatty acid metal salts and polymer fine particles. These may be used alone as a single type, or in a combination of two or more types.

Examples of fatty acid metal salts include, but are not limited to, zinc stearate, calcium stearate, and stearic acid.

As the polymer fine particles, polymer fine particles produced by soap-free emulsion polymerization are preferable, and examples include, but are not limited to, polymethyl methacrylate fine particles and polystyrene fine particles.

The volume average particle diameter of the polymer fine particles is not limited and can be selected as appropriate according to the intended purpose, but particles with a relatively narrow particle size distribution are preferable, and particles with a volume average particle diameter of 0.01 μm to 1 μm are suitable.

The content of the cleanability improver is not limited and can be selected as appropriate according to the intended purpose, but is preferably 0.01 parts by mass to 5.00 parts by mass, and more preferably 0.10 parts by mass to 2.00 parts by mass, relative to 100 parts by mass of the resin particle.

The toner according to embodiments of the present disclosure may be a magnetic toner or a non-magnetic toner, but is preferably a non-magnetic toner.

### <<Magnetic Material>>

The magnetic material is not limited and can be selected as appropriate according to the intended purpose, and examples include, but are not limited to, iron powder, magnetite, and ferrite. These may be used alone as a single type, or in a combination of two or more types. Among these magnetic materials, white magnetic materials are preferable in terms of the color tone.

The content of the magnetic material is not limited and can be selected as appropriate according to the intended purpose, but is preferably 20 parts by mass to 200 parts by mass, and more preferably 40 parts by mass to 150 parts by mass, relative to 100 parts by mass of the resin particle.

### <<Shape-Modifying Agent>>

The shape-modifying agent is added to modify the shape of the resin particle.

The shape-modifying agent is not limited and can be selected as appropriate according to the intended purpose, but preferably contains a layered inorganic mineral in which at least some of the ions between layers of the layered inorganic mineral are modified with organic ions.

The layered inorganic mineral in which at least some of the ions between layers are modified with organic ions is not limited and can be selected as appropriate according to the intended purpose, and examples include, but are not limited to, layered organic minerals having a smectite-based basic crystal structure modified with organic cations. Smectite-group clay minerals have layers that are negatively charged, and cations exist between the layers to compensate for the negative charge. Interlayer compounds can be formed by ion exchange of the cations or adsorption of polar molecules. In addition, metal ions can be introduced by replacing some of the divalent metals of the layered inorganic mineral with trivalent metals. However, because introducing metal anions results in high hydrophilicity, a layered inorganic compound in which at least some of the metal anions are modified with organic anions is preferable.

The layered inorganic mineral in which at least some of the ions between layers are modified with organic ions can be obtained by using an organic cation modifier or an organic anion modifier.

The organic cation modifier is not limited if the layered inorganic material can be modified with organic ions as described above, and examples include, but are not limited to, quaternary alkyl ammonium salts, phosphonium salts, and imidazolium salts. These may be used alone as a single type, or in a combination of two or more types. Among these organic cation modifiers, quaternary alkyl ammonium salts are preferable.

The quaternary alkyl ammonium is not limited, and examples include, but are not limited to trimethylstearylammonium, dimethylstearylbenzylammonium, and oleylbis(2-hydroxyethyl)methylammonium.

The organic anion modifier is not limited if the layered inorganic material can be modified with organic ions as described above, and examples include, but are not limited to, sulfates, sulfonates, carboxylates, and phosphates having a branched, unbranched, or cyclic alkyl (C1 to C44) group, a branched, unbranched, or cyclic alkenyl (C1 to C22) group, a branched, unbranched, or cyclic alkoxy (C8 to C32) group, a branched, unbranched, or cyclic hydroxyalkyl (C2 to C22) group, an ethylene oxide skeleton, or a propylene oxide skeleton. These may be used alone as a single type, or in a combination of two or more types. Among these organic anion modifiers, carboxylic acids having an ethylene oxide skeleton are preferable.

When the resin particle is manufactured by the method later-described in (Method for Manufacturing Resin Particle) section, the shape-modifying agent is preferably added in the “oil phase preparation step” described below.

As a result of modifying at least some of the ions between the layers of the layered inorganic mineral with organic ions, because an appropriate level of hydrophobicity is obtained, the oil phase containing the material of the resin particle has non-Newtonian viscosity, allowing the shape of the resin particle to be modified. At this time, the content of the shape-modifying agent in the material of the resin particle is preferably 0.05% by mass to 10% by mass, and more preferably 0.05% by mass to 5% by mass, relative to the total amount of the material of the resin particle.

Furthermore, the layered inorganic mineral is not limited and can be selected as appropriate according to the intended purpose, and examples include, but are not limited to, montmorillonite, bentonite, hectorite, attapulgite, sepiolite, and mixtures thereof.

Among these layered inorganic minerals, organically modified montmorillonite and organically modified bentonite and preferable as the layered inorganic mineral in which at least some of the ions between layers are modified with organic ions because the toner characteristics are not affected when the resin particle is used in a toner, the viscosity can be easily adjusted, and the amount added can be made small.

Examples of commercially available layered inorganic minerals in which at least some of the ions between layers are modified with organic ions include, but are not limited to, quaternium-18 bentonite such as Bentone 3, Bentone 38, Bentone 38V (all manufactured by Rheox Inc.), Tixogel VP (manufactured by United Catalysts), Claytone 34, Claytone 40, Claytone XL (all manufactured by Southern Clay); stearalkonium bentonite such as Bentone 27 (manufactured by Rheox Inc.), Tixogel LG (manufactured by United Catalysts), Claytone AF, Claytone APA (all manufactured by Southern Clay); and quaternium-18/benzalkonium bentonite such as Claytone HT, Claytone PS (all manufactured by Southern Clay). Among these layered inorganic minerals, Claytone AF and Claytone APA are preferable.

In addition, as the layered inorganic mineral in which at least some of the ions between layers are modified with organic ions, layered organic minerals obtained by modifying DHT-4A (registered trademark) (manufactured by Kyowa Chemical Industry Co., Ltd.) with an organic anion modifier represented by the following general formula (V) are more preferable. Examples of the organic anion modifier represented by the following general formula (V) include, but are not limited to, Hitenol (registered trademark) 330T (manufactured by Dai-ichi Kogyo Seiyaku Co., Ltd.).

$${{R}_{1} ( {O R}_{2} )}_{n} {OSO}_{3} M \qquad ( V )$$

(where, in general formula (V), R₁ represents an alkyl group having 13 carbon atoms, R₂ represents an alkylene group having 2 to 6 carbon atoms, n represents an integer of 2 to 10, and M represents a monovalent metal element)

### —Volume Average Particle Diameter of Resin Particle—

The volume average particle diameter (D4) of the resin particles is not limited and can be appropriately selected according to the purpose, but is preferably 3 μm or more and 7 μm or less.

Furthermore, the ratio (D4/Dn) of the volume average particle diameter (D4) of the resin particles to the number average particle diameter (Dn) of the resin particles is not limited and can be selected as appropriate according to the intended purpose, but is preferably 1.2 or less.

Furthermore, the resin particles preferably contain 1 number % to 10 number % of a component having a volume average particle diameter of 2 μm or less.

The volume average particle diameter (D4), number average particle diameter (Dn), and the ratio (D4/Dn) of the resin particles can be measured using, for example, a Coulter Multisizer 3 (manufactured by Beckman Coulter, Inc.). Herein, values using Coulter Multisizer 3 are used. The measurement method is described below.

First, a mixed solution is obtained by adding 0.1 mL to 5 mL of a surfactant (preferably polyoxyethylene alkyl ether (nonionic surfactant)) as a dispersant into 100 mL to 150 mL of an electrolytic aqueous solution. Then, 2 mg to 20 mg of a measurement sample is added to the mixed solution. The electrolytic aqueous solution in which the measurement sample has been suspended is subjected to dispersion treatment for about 1 minute to 3 minutes with an ultrasonic disperser, and the volume and number of the resin particles are measured by the measurement device (Coulter Multisizer 3) using a 100 μm aperture as the aperture to calculate the volume distribution and number distribution. From the obtained distributions, the volume average particle diameter (D4) and number average particle diameter (Dn) of the resin particles can be determined.

Note that the electrolytic aqueous solution is a 1% by mass sodium chloride aqueous solution prepared using primary sodium chloride. For example, ISOTON-3 (manufactured by Beckman Coulter, Inc.) can be used.

As channels, 13 channels are used, the channels being 2.00 μm or more and less than 2.52 μm, 2.52 μm or more and less than 3.17 μm, 3.17 μm or more and less than 4.00 μm, 4.00 μm or more and less than 5.04 μm, 5.04 μm or more and less than 6.35 μm, 6.35 μm or more and less than 8.00 μm, 8.00 μm or more and less than 10.08 μm, 10.08 μm or more and less than 12.70 μm, 12.70 μm or more and less than 16.00 μm, 16.00 μm or more and less than 20.20 μm, 20.20 μm or more and less than 25.40 μm, 25.40 μm or more and less than 32.00 μm, and 32.00 μm or more and less than 40.30 μm, targeting particles with a particle diameter of 2.00 μm or more and less than 40.30 μm.

### —Glass Transition Temperature (Tg) and Melting Point (Tm)—

### ——Measurement Method of Glass Transition Temperature (Tg) and Melting Point (Tm)——

The glass transition temperature (Tg) and melting point (Tm) herein can be measured using, for example, a DSC system (differential scanning calorimeter) (“Q-200”, manufactured by TA Instruments).

Specifically, the glass transition temperature (Tg) and melting point (Tm) of a target sample can be measured by the following procedure.

First, about 5.0 mg of the target sample is put into an aluminum sample container, and the sample container is placed on a holder unit and set in an electric furnace. Next, under a nitrogen atmosphere, the target sample is heated from −80° C. to 150° C. at a heating rate of 10° C./min (first temperature ramp). Then, the target sample is cooled from 150° C. to −80° C. at a cooling rate of 10° C./min, and further heated to 150° C. at a heating rate of 10° C./min (second temperature ramp). In each of the first temperature ramp and the second temperature ramp, a DSC curve is measured using a differential scanning calorimeter (“Q-200”, manufactured by TA Instruments).

From the obtained DSC curve, using an analysis program in the Q-200 system, the DSC curve from the first temperature ramp is selected, and the glass transition temperature of the target sample during the first temperature ramp can be determined. Similarly, the DSC curve during the second temperature ramp is selected, and the glass transition temperature of the target sample during the second temperature ramp can be determined.

Also, from the obtained DSC curve, using an analysis program in the Q-200 system, the DSC curve during the first temperature ramp is selected, and the endothermic peak top temperature of the target sample during the first temperature ramp can be determined as the melting point. Similarly, the DSC curve during the second temperature ramp is selected, and the endothermic peak top temperature of the target sample during the second temperature ramp can be determined as the melting point.

Herein, when the resin particles are used as the target sample, the glass transition temperature during the first temperature ramp is denoted as [Tg1st], and the glass transition temperature during the second temperature ramp is denoted as [Tg2nd].

In addition, herein, unless otherwise specified, for the glass transition temperature and melting point of the amorphous polyester resin A, the amorphous polyester resin B, the crystalline polyester resin C, and other constituent components such as the release agent, the endothermic peak top temperature during the second temperature ramp is taken as the melting point of each target sample, and the Tg during the second temperature ramp is taken as the Tg of each target sample.

### ——Tg1st (Resin Particles)——

The glass transition temperature [Tg1st (resin particles)] during the first temperature ramp of the differential scanning calorimetry (DSC) of the resin particles is not limited and can be selected as appropriate according to the intended purpose, but from the viewpoint of the low-temperature fixability, is preferably 20° C. or higher and 50° C. or lower, and more preferably 35° C. or higher and 45° C. or lower. When the [Tg1st (resin particles)] is 20° C. or higher, deterioration of the heat resistant storage stability, blocking in a developing device, and filming on a photoconductor can be restricted. When the [Tg1st (resin particles)] is 50° C. or lower, a decrease in the low-temperature fixability of the resin particles can be restricted.

In a toner, when the glass transition temperature (Tg) becomes about 50° C. or lower, toner aggregation easily occurs due to temperature changes assumed to occur during transport in summer or in tropical regions, and in storage environments. As a result, the toner solidifies in the toner bottle and adheres to the interior of a developing device. Also, supply failures due to the toner clogging in the toner bottle and image abnormalities due to the toner adhering to the interior of developing machine easily occur.

Even if the toner containing the resin particles has a lower glass transition temperature (Tg) than conventional toners, when the amorphous polyester resin A, which is the low Tg component in the toner, is non-linear, the toner can maintain heat resistant storage stability. In particular, when the amorphous polyester resin A has a urethane bond or a urea bond with a high cohesive force, the effect of maintaining the heat resistant storage stability becomes more pronounced.

### ——[Tg2nd (Resin Particles)]——

The glass transition temperature [Tg2st (resin particles)] during the second temperature ramp of the differential scanning calorimetry (DSC) of the resin particles is not limited and can be selected as appropriate according to the intended purpose, but is preferably 0° C. or higher and 30° C. or lower, and more preferably 0° C. or higher and 15° C. or lower. When the [Tg2nd (resin particles)] is 0° C. or higher, a decrease in the blocking resistance of a fixed image (printed article) can be restricted. Further, when the [Tg2nd (resin particles)] is 30° C. or lower, a decrease in the low-temperature fixability and glossiness can be restricted.

The [Tg2nd (resin particles)] can be adjusted, for example, by the Tg and blending amount of the crystalline resin.

——Difference [((Tg1st (resin particles))−(Tg2nd (resin particles))]——

The difference [(Tg1st (resin particles))−(Tg2nd (resin particles))] between the glass transition temperature [Tg1st (resin particles)] during the first temperature ramp and the glass transition temperature [Tg2nd (resin particles)] during the second temperature ramp of the differential scanning calorimetry (DSC) of the resin particles is not limited and can be selected as appropriate according to the intended purpose, but is preferably 10° C. or more. The upper limit of the difference [[Tg1st (resin particles)]-[Tg2nd (resin particles)] is not limited and can be selected as appropriate according to the intended purpose, but is preferably 50° C. or less.

When the difference [(Tg1st (resin particles))−(Tg2nd (resin particles))] is 10° C. or more, there is an advantage that excellent low-temperature fixability is obtained. In addition, the fact that the difference [(Tg1st (resin particles))−(Tg2nd (resin particles))] is 10° C. or more means that the crystalline polyester resin C and the amorphous polyester resin A and amorphous polyester resin B, which existed in an incompatible state before heating (before the first temperature ramp), enter a compatible state after heating (after the first temperature ramp). Note that the compatible state after heating does not need to be a completely compatible state.

——Tg2nd (THF-insoluble component)——

The glass transition temperature [Tg2st (THF-insoluble component)] during the second temperature ramp of the differential scanning calorimetry (DSC) of the tetrahydrofuran (THF) insoluble component of the resin particles is not limited, and can be selected as appropriate according to the intended purpose, but is preferably −40° C. or higher and 30° C. or lower, and more preferably 0° C. or higher and 20° C. or lower. When the [Tg2nd (THF-insoluble component)] is −40° C. or higher, an advantage is obtained in that a decrease in the blocking resistance of a fixed image (printed article) can be restricted. Further, when the [Tg2nd (THF-insoluble component)] is 30° C. or lower, an advantage is obtained in that a decrease in the low-temperature fixability and glossiness can be restricted.

The [Tg2nd (THF-insoluble component)] can be adjusted, for example, by changing the number of carbon atoms of the polyhydric alcohol and polycarboxylic acid of the amorphous polyester resin A.

### ——Melting Point (Tm)——

The melting point (Tm) of the resin particles is not limited and can be selected as appropriate according to the intended purpose, but is preferably 60° C. or higher and 80° C. or lower.

### —Storage Modulus—

### ——Measurement Method of Storage Modulus G′——

The storage modulus (G′) under various conditions can be measured using, for example, a dynamic viscoelasticity measurement device (ARES, manufactured by TA Instruments). The frequency during the measurement is 1 Hz.

Specifically, a measurement sample is molded into a pellet with a diameter of 8 mm and a thickness of 1 mm to 2 mm, fixed to a parallel plate with a diameter of 8 mm and stabilized at 40° C., and then heated to 200° C. at a heating rate of 2.0° C./min at a frequency of 1 Hz (6.28 rad/s) and a strain amount of 0.1% (strain amount control mode) to measure the storage modulus.

Herein, the storage modulus at 40° C. is sometimes denoted as [G′(40)], and the storage modulus at 100° C. as [G′(100)].

### [G′(100) (THF-Insoluble Component)], and [(G′(40) (THF-Insoluble Component)]/[G′(100) (THF-Insoluble Component))]

The storage modulus [G′(100) (THF-insoluble component)] at 100° C. of the tetrahydrofuran (THF) insoluble component of the resin particles is not limited and can be selected as appropriate according to the intended purpose, but is preferably 1.0×10⁵ Pa to 1.0×10⁷ Pa, and more preferably 5.0×10⁵ Pa to 5.0×10⁶ Pa. When the storage modulus [G′(100) (THF-insoluble component)] is within the more preferable range, there is an advantage is obtained in that more excellent low-temperature fixability is obtained.

The ratio [(G′(40) (THF-insoluble component))/(G′(100) (THF-insoluble component))] between the storage modulus [G′(40) (THF-insoluble component)] at 40° C. and the storage modulus [G′(100) (THF-insoluble component)] at 100° C. of the THF-insoluble component of the resin particles is not limited and can be selected as appropriate according to the intended purpose, but is preferably 3.5×10 or less. When the ratio [(G′(40) (THF-insoluble component))/(G′(100) (THF-insoluble component))] is 3.5×10 or less, a decrease in the low-temperature fixability can be restricted.

Also, when the resin particles has a [G′(100) (THF-insoluble component)] of 1.0×10⁵ Pa to 1.0×10⁷ Pa, and the ratio [(G′(40) (THF-insoluble component))/(G′(100) (THF-insoluble component))] is 3.5×10 or less, there is an advantage in that compatibilization between the crystalline resin and the amorphous polyester resin, which is the high Tg component, is promoted, the ½ flow temperature obtained using a thermal flow evaluation device (flow tester) decreases, and the image gloss improves.

The [G′(100) (THF-insoluble component)] and [G′(40) (THF-insoluble component)] can be adjusted, for example, by the resin composition (bifunctional or higher polyhydric alcohol and bifunctional or higher acid component).

Specifically, for example, the adjustment can be made as follows. To increase the storage modulus (G′), an adjustment can be made by shortening the distance between ester bonds in the resin, or by using a resin composition having an aromatic ring. To decrease the storage modulus (G′), an adjustment can be made by using a linear polyester resin, or by using a polyhydric alcohol having an alkyl group in a side chain as a constituent component of the polyester resin.

### ——THF-Insoluble Component——

The THF-insoluble component of the resin particles can be obtained as follows.

After adding 1 part of the resin particles to 100 parts of tetrahydrofuran (THF) and refluxing for 6 hours, the insoluble component is made to settle with a centrifuge, and the insoluble component and the supernatant liquid are separated.

### —Measurement of Molecular Weight—

The molecular weight of each constituent component of the resin particles can be measured, for example, under the following analysis conditions.

### [Analysis Conditions]

Gel permeation chromatograph (GPC) measurement device: GPC-8220GPC (manufactured by Tosoh Corporation)
Column: TSKgel (registered trademark) SuperHZM-H 15 cm 3-series (manufactured by Tosoh Corporation)
Temperature: 40° C.
Detector: RI (refractive index) detector
Solvent: Chloroform
Flow rate: 0.35 mL/min
Sample: Injection of 100 μL of 0.1% by mass sample
Sample Pretreatment: After dissolving the resin particles in chloroform at 0.1% by mass, a dissolved solution in which the soluble component is dissolved is obtained by stirring at 25° C. for 30 minutes. The solution is filtered through a membrane filter with an opening of 0.2 μm, and the filtrate is used as a chloroform sample solution.

Then, 100 μL of the chloroform sample solution is injected for measurement.

In measuring the molecular weight of the sample, the molecular weight distribution of the sample is calculated from the relationship between the logarithmic value of a calibration curve created with several types of monodisperse polystyrene standard samples and the count number. As standard polystyrene samples for creating the calibration curve, for example, Std. No S-6550, S-1700, S-740, S-321, S-129, S-10, S-2.9, and S-0.6 of Showdex (registered trademark) STANDARD (manufactured by Showa Denko K.K.) are used.

The method for manufacturing the polyester aqueous dispersion is not limited. However, the polyester aqueous dispersion is preferably produced by the method for manufacturing a polyester aqueous dispersion according to embodiments of the present disclosure described later.

### (Method for Manufacturing Polyester Aqueous Dispersion)

The method for manufacturing a polyester aqueous dispersion comprises: a) a step of preparing an oil phase by dissolving or dispersing an amorphous polyester resin in an organic solvent (hereinafter sometimes referred to as “oil phase preparation step”); b) a step of adding an aqueous medium to the oil phase to cause phase inversion from a water-in-oil dispersion liquid to an oil-in-water dispersion liquid (hereinafter sometimes referred to as “phase inversion emulsification step”); and further contains other steps such as an aqueous phase preparation step and a solvent removal step, if preferable.

### <Oil Phase Preparation Step>

The oil phase preparation step is a step of preparing an oil phase by dissolving or dispersing an amorphous polyester resin in an organic solvent.

The organic solvent is not limited and can be selected as appropriate according to the intended purpose, but an organic solvent with a boiling point of lower than 150° C. is preferable because the organic solvent is easily removed.

The organic solvent having a boiling point of less than 150° C. is not limited and can be selected as appropriate according to the intended purpose, and examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone as a single type, or in a combination of two or more types. Among these organic solvents, ethyl acetate, toluene, xylene, benzene, methylene chloride, 1,2-dichloroethane, chloroform, and carbon tetrachloride are preferable, and ethyl acetate is more preferable.

The amount of the organic solvent used is not limited and can be selected as appropriate according to the intended purpose, but is preferably 40 parts by mass to 300 parts by mass, more preferably 60 parts by mass to 140 parts by mass, and even more preferably 80 parts by mass to 120 parts by mass, relative to 100 parts by mass of the raw material of the resin particles.

The preparation method of the oil phase is not limited and can be selected as appropriate according to the intended purpose, and examples include, but are not limited to, a method of gradually adding the material of the oil phase into the organic solvent while stirring to dissolve or disperse the material of the oil phase.

For the dispersion, a known device can be used. For example, a disperser such as a bead mill or a disk mill can be used.

### <Aqueous Phase (Aqueous Medium) Preparation Step>

The aqueous phase preparation step is a step of preparing an aqueous phase (aqueous medium).

The aqueous medium is not limited and can be selected as appropriate according to the intended purpose, and examples include, but are not limited to, water, a solvent miscible with water, and mixtures thereof. These may be used alone as a single type, or in a combination of two or more types. Among these aqueous media, water is preferred.

The solvent miscible with water is not limited and can be selected as appropriate according to the intended purpose, and examples include, but are not limited to, alcohols, dimethylformamide, tetrahydrofuran, ethyl acetate, cellosolves, and lower ketones.

The alcohol is not limited and can be selected as appropriate according to the intended purpose, and examples include, but are not limited to, methanol, isopropanol, and ethylene glycol.

The lower ketone is not limited and can be selected as appropriate according to the intended purpose, and examples include, but are not limited to, acetone and methyl ethyl ketone.

### <Phase Inversion Emulsification Step>

The phase inversion emulsification step is a step of adding an aqueous medium to the oil phase to cause phase inversion from a water-in-oil dispersion liquid to an oil-in-water dispersion liquid. As a result, a polyester aqueous dispersion (oil droplets) is obtained.

The method for phase inversion emulsification of the amorphous polyester resin A in the aqueous medium is not limited and can be selected as appropriate according to the intended purpose, and examples include, but are not limited to, a method of obtaining a polyester aqueous dispersion by phase inversion emulsification, in which the oil phase is neutralized with a base or the like, and an aqueous phase is added thereto to cause phase inversion from a water-in-oil dispersion liquid to an oil-in-water dispersion liquid.

As a base used for neutralizing the oil phase, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

Neutralization is carried out while uniformly mixing and dispersing the mixture by using a general-use stirrer or a dispersion device. The dispersing device is not limited, and examples thereof include, but are not limited to, an ultrasonic disperser, a bead mill, a ball mill, a roll mill, a homomixer, an ultramixer, a disperser mixer, a penetrating-type high-pressure dispersion device, a collision-type high-pressure dispersion device, a multi-hole type high-pressure dispersion device, an ultra-high pressure homogenizer, and an ultrasonic homogenizer. A general-use stirrer and a dispersion device may be used in combination.

The amount of the aqueous medium used when performing phase-inversion emulsification of the oil phase containing the amorphous polyester resin A is not limited, and can be selected as appropriate according to the intended purpose. The amount of the aqueous medium used is preferably 50 parts by mass to 2,000 parts by mass, and more preferably 100 parts by mass to 1,000 parts by mass, relative to 100 parts by mass of the amorphous polyester resin A. When the amount of the aqueous medium used is 50 parts by mass or more relative to 100 parts by mass of the amorphous polyester resin A, it is possible to prevent the dispersion state of the resin particle material from deteriorating and restrict the failure to obtain a polyester aqueous dispersion with a specified particle size. Furthermore, when the amount of the aqueous medium used is 2,000 parts by mass or less relative to 100 parts by mass of the amorphous polyester resin A, it is possible to restrict an increase in production cost.

When phase inversion emulsification of the oil phase containing the amorphous polyester resin A is performed, a dispersant may be used from the viewpoint of stabilizing a dispersion such as oil droplets, forming a desired shape, and sharpening the particle size distribution.

The dispersant is not limited and can be selected as appropriate according to the intended purpose, and examples include, but are not limited to, surfactants, inorganic compound dispersants that are poorly soluble in water, and polymer-based protective colloids.

These may be used alone as a single type, or in a combination of two or more types. Among these dispersants, surfactants are preferable.

The surfactant is not limited and can be selected as appropriate according to the intended purpose, and examples include, but are not limited to, anionic surfactants, cationic surfactants, nonionic surfactants, and amphoteric surfactants.

The anionic surfactant is not limited, can be selected as appropriate according to the intended purpose, and examples include, but are not limited to, alkyl sulfates, alkylbenzene sulfonates, α-olefin sulfonates, and phosphoric acid esters. Among these anionic surfactants, alkyl sulfates are preferable because a salt with an aggregated salt is not easily formed during production of the resin particles, widening the selection of aggregated salts.

The amount of the surfactant is preferably 0% by mass to 3.0% by mass relative to 100% by mass of the resin particles. If the amount of the surfactant exceeds 3.0% by mass, the shell material becomes too stable and does not easily adhere to the core, and the chargeability of the resin particles becomes non-uniform.

The phase inversion emulsification can be performed using a stirring blade.

The stirring blade is not limited and can be selected as appropriate according to the viscosity of the solution, and examples include, but are not limited to, an anchor blade, a turbine blade, a Pfaudler blade, a Fullzone blade, a Maxblend blade, or a half-moon blade.

The peripheral speed when using the stirring blade is not limited and can be selected as appropriate according to the intended purpose, it is preferably 0.4 m/s to 2.0 m/s, and more preferably 0.7 m/s to 1.5 m/s.

The volume average particle diameter of the polyester aqueous dispersion (oil droplets) is not limited and can be selected as appropriate according to the intended purpose, but is preferably 20 nm to 200 nm, and more preferably 20 nm to 100 nm.

### <Solvent Removal Step>

The solvent removal step is a step of removing the organic solvent from the polyester aqueous dispersion obtained in the phase inversion emulsification step.

The method of removing the organic solvent from the polyester aqueous dispersion is not limited and can be selected as appropriate according to the intended purpose, and examples include, but are not limited to, a method of evaporating the organic solvent in the fine particle dispersion liquid (oil droplets) by gradually raising the temperature of the entire reaction system, a method of removing the organic solvent in the fine particle dispersion liquid (oil droplets) by spraying the fine particle dispersion liquid into a dry atmosphere, and a method of evaporating and removing the organic solvent by reducing the pressure of the fine particle dispersion liquid. These may be used alone as a single type, or in a combination of two or more types.

The dry atmosphere into which the fine particle dispersion liquid is sprayed is not limited and can be selected as appropriate according to the intended purpose, and various gas flows heated to a temperature at or above the boiling point of the highest boiling point solvent used are generally used. Examples of the heated gas include, but are not limited to, air, nitrogen, carbon dioxide gas, and combustion gas.

The solvent removal step can be performed using a device. For example, a spray dryer, a belt dryer, or a rotary kiln can be used, and the target quality can be sufficiently obtained by a treatment performed for a short time.

### (Method for Manufacturing Resin Particle)

The method for manufacturing a resin particle according to embodiments of the present disclosure includes: a) a step of preparing an oil phase by dissolving or dispersing at least an amorphous polyester resin in an organic solvent (hereinafter sometimes referred to as “oil phase preparation step”); b) a step of adding an aqueous medium to the oil phase to cause phase inversion from a water-in-oil dispersion liquid to an oil-in-water dispersion liquid (hereinafter sometimes referred to as “phase inversion emulsification step”); c) a step of aggregating particles of the oil-in-water dispersion liquid to obtain a resin particle (hereinafter sometimes referred to as “aggregation step”); and a step of forming a shell layer; and further contains other steps such as an aqueous phase preparation step, a solvent removal step, a fusion step, a washing step, a drying step, a classification step, and an annealing step, if preferable.

### <Oil Phase Preparation Step>

The oil phase preparation step is a step of preparing an oil phase by dissolving or dispersing at least an amorphous polyester resin in an organic solvent.

The amorphous polyester resin is as described in the <Amorphous Polyester Resin B> section of (Polyester Aqueous Dispersion, Resin Particle, Resin Particle for Toner, and Resin Particle for Paint), and the oil phase preferably contains the amorphous polyester resin B.

The oil phase may further contain the crystalline resin, the colorant, the release agent, and the like, if preferable.

The organic solvent is not limited and can be selected as appropriate according to the intended purpose, but an organic solvent with a boiling point of lower than 150° C. is preferable because the organic solvent is easily removed.

The organic solvent having a boiling point of less than 150° C. is not limited and can be selected as appropriate according to the intended purpose, and examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone as a single type, or in a combination of two or more types. Among these organic solvents, ethyl acetate, toluene, xylene, benzene, methylene chloride, 1,2-dichloroethane, chloroform, and carbon tetrachloride are preferable, and ethyl acetate is more preferable.

The amount of the organic solvent used is not limited and can be selected as appropriate according to the intended purpose, but is preferably 40 parts by mass to 300 parts by mass, more preferably 60 parts by mass to 140 parts by mass, and even more preferably 80 parts by mass to 120 parts by mass, relative to 100 parts by mass of the raw material of the resin particles.

The preparation method of the oil phase is not limited and can be selected as appropriate according to the intended purpose, and examples include, but are not limited to, a method of gradually adding the material of the oil phase into the organic solvent while stirring to dissolve or disperse the material of the oil phase.

For the dispersion, a known device can be used. For example, a disperser such as a bead mill or a disk mill can be used.

### <Aqueous Phase (Aqueous Medium) Preparation Step>

The aqueous phase preparation step is a step of preparing an aqueous phase (aqueous medium).

The aqueous medium is not limited and can be selected as appropriate according to the intended purpose, and examples include, but are not limited to, water, a solvent miscible with water, and mixtures thereof. These may be used alone as a single type, or in a combination of two or more types. Among these aqueous media, water is preferred.

The solvent miscible with water is not limited and can be selected as appropriate according to the intended purpose, and examples include, but are not limited to, alcohols, dimethylformamide, tetrahydrofuran, ethyl acetate, cellosolves, and lower ketones.

The alcohol is not limited and can be selected as appropriate according to the intended purpose, and examples include, but are not limited to, methanol, isopropanol, and ethylene glycol.

The lower ketone is not limited and can be selected as appropriate according to the intended purpose, and examples include, but are not limited to, acetone and methyl ethyl ketone.

### <Phase Inversion Emulsification Step>

The phase inversion emulsification step is a step of adding an aqueous medium to the oil phase to cause phase inversion from a water-in-oil dispersion liquid to an oil-in-water dispersion liquid. As a result, a fine particle dispersion liquid (oil droplets) is obtained.

The method for phase inversion emulsification of the dispersion liquid containing the amorphous polyester resin B in the aqueous medium is not limited and can be selected as appropriate according to the intended purpose, and examples include, but are not limited to, a method of obtaining a fine particle dispersion liquid by phase inversion emulsification, in which the oil phase is neutralized with a base or the like, and then an aqueous phase is added thereto to cause phase inversion from a water-in-oil dispersion liquid to an oil-in-water dispersion liquid.

The method for phase inversion emulsification of the amorphous polyester resin A in the aqueous medium is not limited and can be selected as appropriate according to the intended purpose, and examples include, but are not limited to, a method of obtaining a fine particle dispersion liquid by phase inversion emulsification, in which the oil phase is neutralized with a base or the like, and then an aqueous phase is added thereto to cause phase inversion from a water-in-oil dispersion liquid to an oil-in-water dispersion liquid.

As a base used for neutralizing the oil phase, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

Neutralization is carried out while uniformly mixing and dispersing the mixture by using a general-use stirrer or a dispersion device. The dispersing device is not limited, and examples thereof include, but are not limited to, an ultrasonic disperser, a bead mill, a ball mill, a roll mill, a homomixer, an ultramixer, a disperser mixer, a penetrating-type high-pressure dispersion device, a collision-type high-pressure dispersion device, a multi-hole type high-pressure dispersion device, an ultra-high pressure homogenizer, and an ultrasonic homogenizer. A general-use stirrer and a dispersion device may be used in combination.

The amount of the aqueous medium used when performing phase inversion emulsification of the oil phase containing the resin particle material is not limited, and can be selected as appropriate according to the intended purpose. The amount of the aqueous medium used is preferably 50 parts by mass to 2,000 parts by mass, and more preferably 100 parts by mass to 1,000 parts by mass, relative to 100 parts by mass of the resin particle material. When the amount of the aqueous medium used is 50 parts by mass or more relative to 100 parts by mass of the resin particle material, it is possible to prevent the dispersion state of the resin particle material from deteriorating and restrict the failure to obtain resin particles with a specified particle size. Furthermore, when the amount of the aqueous medium used is 2,000 parts by mass or less relative to 100 parts by mass of the resin particle material, it is possible to restrict an increase in production cost.

When the oil phase containing the resin particle material subjected to phase inversion emulsification, it is preferable to use a dispersant to stabilize the dispersion such as oil droplets, form a desired shape, and obtain a narrow particle size distribution.

The dispersant is not limited and can be selected as appropriate according to the intended purpose, and examples include, but are not limited to, surfactants, inorganic compound dispersants that are poorly soluble in water, and polymer-based protective colloids.

These may be used alone as a single type, or in a combination of two or more types. Among these dispersants, surfactants are preferable.

The surfactant is not limited and can be selected as appropriate according to the intended purpose, and examples include, but are not limited to, anionic surfactants, cationic surfactants, nonionic surfactants, and amphoteric surfactants.

The anionic surfactant is not limited, can be selected as appropriate according to the intended purpose, and examples include, but are not limited to, alkylbenzene sulfonates, α-olefin sulfonates, and phosphoric acid esters. Among these anionic surfactants, alkyl sulfates are preferable.

The phase inversion emulsification can be performed using a stirring blade.

The stirring blade is not limited and can be selected as appropriate according to the viscosity of the solution, and examples include, but are not limited to, an anchor blade, a turbine blade, a Pfaudler blade, a Fullzone blade, a Maxblend blade, or a half-moon blade.

The peripheral speed when using the stirring blade is not limited and can be selected as appropriate according to the intended purpose, it is preferably 0.4 m/s to 2.0 m/s, and more preferably 0.7 m/s to 1.5 m/s.

The volume average particle diameter of the dispersion (oil droplets) in the fine particle dispersion liquid is not limited and can be selected as appropriate according to the purpose, but it is preferably 50 nm to 2,000 nm, and more preferably 50 nm to 500 nm.

### <Solvent Removal Step>

The solvent removal step is a step of removing the organic solvent from the fine particle dispersion liquid obtained in the phase inversion emulsification step to obtain core particles.

The method of removing the organic solvent from the fine particle dispersion liquid is not limited and can be selected as appropriate according to the intended purpose, and examples include, but are not limited to, a method of evaporating the organic solvent in the fine particle dispersion liquid (oil droplets) by gradually raising the temperature of the entire reaction system, a method of removing the organic solvent in the fine particle dispersion liquid (oil droplets) by spraying the fine particle dispersion liquid into a dry atmosphere, and a method of evaporating and removing the organic solvent by reducing the pressure of the fine particle dispersion liquid. These may be used alone as a single type, or in a combination of two or more types.

The dry atmosphere into which the fine particle dispersion liquid is sprayed is not limited and can be selected as appropriate according to the intended purpose, and various gas flows heated to a temperature at or above the boiling point of the highest boiling point solvent used are generally used. Examples of the heated gas include, but are not limited to, air, nitrogen, carbon dioxide gas, and combustion gas.

The solvent removal step can be performed using a device. For example, a spray dryer, a belt dryer, or a rotary kiln can be used, and the target quality can be sufficiently obtained by a treatment performed for a short time.

### <Aggregation Step>

The aggregation step is a step of aggregating the particles of the oil-in-water dispersion liquid to obtain aggregated particles.

The method of aggregating the oil droplets or the core particles is not limited and can be selected as appropriate from known methods according to the intended purpose, and examples include, but are not limited to, a method of adding an aggregating agent, and a method of performing pH adjustment.

The aggregating agent is not limited and can be selected as appropriate according to the intended purpose, and examples include, but are not limited to, aluminum chloride, zinc sulfate, magnesium sulfate, aluminum sulfate, potassium aluminum sulfate, sodium chloride, sodium bromide, sodium iodide, sodium fluoride, sodium acetate, sodium acetoacetate, lithium chloride, lithium bromide, lithium iodide, lithium fluoride, lithium acetate, lithium acetoacetate, potassium chloride, potassium bromide, potassium iodide, potassium fluoride, potassium acetoacetate, magnesium bromide, magnesium chloride, magnesium iodide, magnesium fluoride, magnesium acetate, magnesium acetoacetate, calcium chloride, calcium bromide, barium bromide, barium chloride, barium iodide, barium fluoride, barium acetate, barium acetoacetate, strontium bromide, strontium chloride, strontium iodide, strontium fluoride, strontium acetate, strontium acetoacetate, zinc bromide, zinc chloride, zinc iodide, zinc fluoride, zinc acetate, zinc acetoacetate, copper bromide, copper chloride, copper iodide, copper fluoride, copper acetate, copper acetoacetate, iron bromide, iron chloride, iron iodide, iron fluoride, iron acetate, and iron acetoacetate. These may be used alone as a single type, or in a combination of two or more types. Among these aggregating agents, divalent metal salts are preferable as the aggregating agent, and trivalent metal salts are more preferable. As a result of using a divalent or higher metal salt, a three-dimensional structure can be formed through metal cross-linking with the carboxyl groups contained in the amorphous polyester resin A or the amorphous polyester resin B, thereby increasing the strength of the resin particles and improving filming resistance.

When adding the aggregating agent, the aggregating agent may be added as is, but it is preferable to add the aggregating agent as an aqueous solution to avoid local high concentrations. Furthermore, it is preferable to add the aggregated salt gradually while observing the particle size of the resin particles.

The temperature of the reaction system during the aggregation step (temperature of the dispersion liquid during aggregation) is not limited, and can be selected as appropriate according to the intended purpose, but is preferably near the glass transition temperature (Tg) of the amorphous polyester resin B. If the temperature is too low, the efficiency may decrease because aggregation does not progress much. Further, if the temperature is too high, the aggregation speed becomes fast, which cause the particle size distribution due to the generation of coarse particles.

The aggregation step is stopped after the aggregated particles reach a target particle diameter.

The method of terminating the aggregation is not limited and can be selected as appropriate according to the intended purpose, and examples include, but are not limited to, a method of adding a salt with a lower ionic valence than the aggregated salt, or a chelating agent; a method of adjusting the pH; a method of lowering the temperature of the reaction system (dispersion liquid) during aggregation; or a method of diluting the concentration of the reaction system (dispersion liquid) during aggregation by adding a large amount of an aqueous medium. These may be used alone as a single type, or in a combination of two or more types.

The volume average particle diameter of the aggregated particles is not limited and can be selected as appropriate according to the intended purpose, but is preferably 3.0 μm to 6.0 μm, and more preferably 4.0 μm to 5.0 μm.

In the aggregation step, a release agent may be added, and a crystalline resin may be added for low-temperature fixability.

As the release agent, the release agents described in the <<Release Agent>> section can be used.

As the crystalline resin, the crystalline resin described in the <<Crystalline Polyester Resin>> section can be used.

When the release agent or the crystalline resin is added in the aggregation step, by preparing a dispersion liquid in which the release agent is dispersed in an aqueous medium or, similarly, a dispersion liquid of the crystalline polyester resin C, and then mixing such a dispersion liquid with the fine particle dispersion liquid (oil droplets) before performing aggregation, aggregated particles in which the release agent or the crystalline resin is uniformly dispersed can be obtained.

The dispersion particle diameter of the release agent in the dispersion liquid is not limited and can be selected as appropriate according to the intended purpose, but is preferably 50 nm or more and 600 nm or less, and more preferably 50 nm or more and 300 nm or less.

Note that, herein, the dispersion particle diameter of the release agent in the dispersion liquid is a volume average particle diameter.

The dispersion particle diameter of the crystalline resin in the dispersion liquid is not limited and can be selected as appropriate according to the intended purpose, but is preferably 50 nm or more and 600 nm or less, and more preferably 50 nm or more and 300 nm or less.

Note that, herein, the dispersion particle diameter of the crystalline resin in the dispersion liquid is a volume average particle diameter.

The dispersion particle diameter of the release agent and the crystalline resin can be measured, for example, using a Nanotrac particle size distribution measurement device (UPA-EX150, manufactured by Nikkiso Co., Ltd., dynamic light scattering method/laser Doppler method).

As a specific measurement method, a measurement is performed after adjusting the dispersion liquid in which the release agent or the crystalline resin is dispersed to a measurement concentration range. At that time, a background measurement is performed in advance using only the dispersion solvent of the dispersion liquid. Such a measurement method enables a measurement from several tens of nanometers to several micrometers.

### <Shell Layer Formation Step>

Furthermore, in order to form a shell layer on the core particles, it is preferable to add the polyester aqueous dispersion during the aggregation step. As a result of forming a shell layer on the core particles, the crystalline resin and the release agent, which cause the filming resistance to deteriorate, can be encapsulated, which improves the filming resistance.

The method for forming the shell layer is not limited and can be selected as appropriate according to the intended purpose, and examples include, but are not limited to, a method of preparing aggregated particles according to the method described above, and then adding the polyester aqueous dispersion to the aggregated particles after the particles have reached a desired particle diameter.

Note that when the method for producing resin particles includes the solvent removal step, the polyester aqueous dispersion may be added after obtaining aggregated particles of the core particles obtained in the solvent removal step.

### <Fusion Step>

The fusion step is a step of fusing the aggregated particles to reduce unevenness and obtain spherical resin particles. In addition, when a resin for forming a shell layer has been added to the resin particles in the aggregation step, the shell layer can be formed on the surface of the aggregated particles by the fusion step.

The method of fusing the aggregated particles is not limited and can be selected as appropriate according to the intended purpose, and examples include, but are not limited to, a method of heating the dispersion liquid of the aggregated particles while stirring the dispersion liquid.

The heating temperature is not limited and can be selected as appropriate according to the intended purpose, but is preferably between the Tg and Tg+20° C. of the amorphous polyester resin B, and more preferably between the Tg and Tg+10° C. When the heating temperature Tg+20° C. of the amorphous polyester resin B or lower, the amorphous polyester resin B and the crystalline resin C become appropriately compatible, and the heat resistant storage stability is improved.

The average circularity of the resin particles is not limited and can be selected as appropriate according to the intended purpose, but from the viewpoint that as the average circularity of the resin particles increases, the resin particles rotate smoothly in a developing nip when used as a toner, allowing more resin particles to be transferred to an electrostatic latent image bearer, the average circularity is preferably 0.95 or more, and more preferably 0.96 or more.

### —Measurement of Average Circularity—

In the present embodiment, the average particle diameter and the average circularity can be measured, for example, using a flow-type particle image analyzer (FPIA-3000, manufactured by Sysmex Corporation).

As a specific measurement method, 0.1 mL to 0.5 mL of a surfactant, preferably an alkylbenzene sulfonate, is added as a dispersant into 100 mL to 150 mL of water in a container, the water having impure solid matter removed in advance, and then approximately 0.1 g to 0.5 g of a measurement sample is further added. The suspension in which the sample is dispersed is subjected to dispersion treatment for approximately 1 minute to 3 minutes using an ultrasonic disperser, and the average particle diameter, average circularity, and standard deviation (SD) of the circularity are measured by the device at a dispersion liquid concentration of 3,000 particles/μL to 10,000 particles/μL.

Note that the particle diameter is taken as a circle equivalent diameter, the average particle diameter is determined as a circle equivalent diameter (number basis), and the analysis conditions for the flow-type particle image analyzer are as follows.

### [Analysis Conditions]

Particle diameter limit: 0.5 μm≤equivalent circle diameter (number basis)≤200.0 μm

Particle shape limit: 0.93<circularity≤1.00

Furthermore, in the present embodiment, the definition of the average circularity is as follows.

(Average circularity)=(Circumference of circle equal to projected area or particle)/(Circumference of projected image of particle)

### <Washing Step>

The washing step is a step of washing the resin particles obtained from the aggregation step or the fusion step.

Since the dispersion liquid of the resin particles obtained by the method described above may contain auxiliary materials such as an aggregating agent in addition to the resin particles, it is preferable to perform washing in order to extract only the resin particles from the dispersion liquid of the resin particles.

The method for washing the resin particles is not limited and can be selected as appropriate according to the intended purpose, and examples include, but are not limited to, a centrifugation method, a vacuum filtration method, and a filter press method.

Although a cake of the resin particles is obtained by any of the washing methods, if the washing is insufficient with a single operation, the obtained cake may be dispersed again in an aqueous solvent to form a slurry, and the step of extracting the resin particles may be repeated by at least one of the washing methods.

When washing is performed by the vacuum filtration method or the filter press method, a method of passing an aqueous solvent through the cake to wash away auxiliary materials encapsulated in the resin particles may also be used.

The aqueous solvent used in the washing step is not limited and can be selected as appropriate according to the intended purpose, and examples include, but are not limited to, water, and mixed solvents containing water and an alcohol.

Examples of the alcohol include, but are not limited to, methanol and ethanol.

Among these solvents, water is preferable as the aqueous solvent from the viewpoints of cost and environmental impact, such as wastewater treatment.

### <Drying Step>

The drying step is a step of drying the resin particles obtained from the washing step.

Because the resin particles washed in the washing step encapsulate a large amount of the aqueous medium, drying is performed in the drying step to remove the aqueous medium, allowing only the resin particles to be obtained.

The drying method is not limited and can be selected as appropriate according to the intended purpose, and examples include, but are not limited to, methods using a dryer such as a spray dryer, a vacuum freeze dryer, a vacuum dryer, a stationary shelf dryer, a moving shelf dryer, a fluidized bed dryer, a rotary dryer, and a stirring dryer.

The final moisture content of the dried resin particles is not limited and can be selected as appropriate according to the intended purpose, but is preferably less than 1% moisture by mass.

If the resin particles dried in the drying step are softly aggregated and inconveniences arise during use, pulverization may be performed to loosen the soft aggregation.

The method of performing the pulverization is not limited and can be selected as appropriate according to the intended purpose, and examples include, but are not limited to, methods using a device such as a jet mill, a Henschel mixer, a super mixer, a coffee mill, an Oster blender, or a food processor.

### <Classification Step>

The classification step is a step of classifying the resin particles obtained from the washing step or the drying step.

The classification method is not limited and can be selected as appropriate according to the intended purpose, and examples include, but are not limited to, a method of removing a fine particle component from a liquid by a cyclone, a decanter, or by centrifugation; and a method of performing a known classification operation after drying.

### <Annealing Step>

The annealing step is a step performed after the drying step when a crystalline resin is added, and is a step of phase-separating the crystalline resin and the amorphous polyester resin.

The methods of performing the annealing treatment are not limited and can be selected as appropriate according to the intended purpose, and examples include, but are not limited to, a method of storing the particles for 10 hours or more at a temperature near the glass transition temperature (Tg) of the crystalline resin.

In the fusion step, when heating is performed at a temperature near or above the glass transition temperature (Tg) of the resin used, the crystalline resin and the amorphous polyester resin may enter a compatible state, which may not allow both heat resistant storage stability and low-temperature fixability to be obtained. However, performing the annealing treatment has an advantage in that phase separation between the crystalline resin and the amorphous resin proceeds such that the resins are no longer in a compatible state.

### (Toner)

The toner according to embodiments of the present disclosure contains toner resin particles according to embodiments of the present disclosure, preferably further contains an external additive, and further contains other components, if preferable.

### <Toner Resin Particles>

The resin particles constituting the toner resin particles are as described in the (Resin Particle) and (Toner Resin Particle) sections, and the details are omitted here.

In the toner, the toner resin particles serve as toner base particles.

The content of the toner resin particles in the toner is not limited and can be selected as appropriate according to the intended purpose. The toner may be the toner resin particles themselves.

### <External Additive>

The external additive is not limited and can be selected as appropriate according to the intended purpose, and examples include, but are not limited to, inorganic fine particles, oxide fine particles, fatty acid metal salts, and additives in which these have been subjected to hydrophobization treatment. These may be used alone as a single type, or in a combination of two or more types.

The average primary particle diameter of the inorganic fine particles is not limited and can be selected as appropriate according to the intended purpose, but is preferably 100 nm or less, more preferably 1 nm or more and 100 nm or less, further preferably 3 nm or more and 70 nm or less, and particularly preferably 5 nm or more and 70 nm or less. When the average primary particle diameter of the inorganic fine particles is 1 nm or more, it is possible to prevent the inorganic fine particles from being buried in the toner and preventing the function from being effectively exhibited. Further, when the average primary particle diameter is 100 nm or less, it is possible to restrict uneven damage to the surface of a photoconductor.

It is preferable to include at least one type of inorganic fine particle having an average primary particle diameter of 20 nm or less and at least one type of inorganic fine particle having a diameter of 30 nm or more.

The BET specific surface area of the inorganic fine particles is not limited and can be selected as appropriate according to the intended purpose, but is preferably 20 m²/g to 500 m²/g.

Examples of the inorganic fine particles are not limited and can be selected as appropriate according to the intended purpose, and examples include silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. These may be used alone as a single type, or in a combination of two or more types. Among these inorganic fine particles, silica or titanium dioxide are preferable.

The oxide fine particles are not limited and can be selected as appropriate according to the intended purpose, and examples include, but are not limited to, titania, alumina, tin oxide, and antimony oxide.

Examples of the fatty acid metal salt include, but are not limited to, zinc stearate and aluminum stearate.

Among these, as the external additive, hydrophobized silica, titania, titanium oxide, and alumina fine particles are preferable.

Examples of the silica fine particles include, but are not limited to, R972, R974, RX200, RY200, R202, R805, or R812 (all manufactured by Nippon Aerosil Co., Ltd.).

Examples of the titania fine particles include, but are not limited to, P-25 (manufactured by Nippon Aerosil Co., Ltd.), STT-30 and STT-65C-S (all manufactured by Titanium Industry Co., Ltd.), TAF-140 (manufactured by Fuji Titanium Industry Co., Ltd.), MT-150W, MT-500B, MT-600B, and MT-150A (all manufactured by Tayca Corporation).

Examples of the hydrophobized titanium oxide fine particles include, but are not limited to, T-805 (manufactured by Nippon Aerosil Co., Ltd.), STT-30A and STT-65S-S (all manufactured by Titanium Industry Co., Ltd.), TAF-500T and TAF-1500T (all manufactured by Fuji Titanium Industry Co., Ltd.), MT-100S and MT-100T (all manufactured by Tayca Corporation), and IT-S (manufactured by Ishihara Sangyo Kaisha, Ltd.).

Hydrophobized oxide fine particles, hydrophobized silica fine particles, hydrophobized titania fine particles, and hydrophobized alumina fine particles can be obtained, for example, by treating hydrophilic fine particles with a silane coupling agent such as methyltrimethoxysilane, methyltriethoxysilane, or octyltrimethoxysilane. Furthermore, are silicone-oil-treated oxide fine particles and inorganic fine particles obtained by treating inorganic fine particles with silicone oil, with heat applied if preferable, are also suitable. Moreover, the external additive may be surface-treated with the fluidity improver described above.

The silicone oil is not limited and can be selected as appropriate according to the intended purpose, and examples include, but are not limited to, dimethyl silicone oil, methyl phenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacrylic-modified silicone oil, and α-methylstyrene-modified silicone oil.

The content of the external additive is not limited and can be selected as appropriate according to the intended purpose, but is preferably 0.1 parts by mass to 5 parts by mass, and more preferably 0.3 parts by mass to 3 parts by mass, relative to 100 parts by mass of the toner.

The method for manufacturing the toner is not limited and can be selected as appropriate from known methods, but the toner is preferably produced by the method for manufacturing a toner according to embodiments of the present disclosure described below.

### (Method for Manufacturing Toner)

The method for manufacturing a toner according to embodiments of the present disclosure includes a mixing step of mixing toner resin particles according to embodiments of the present disclosure and an external additive, and further includes other steps, if preferable.

The details of the toner resin particles are as described in the (Resin Particle) and (Toner Resin Particle) sections, details of the external additive are as described in the <External Additive> section in the (Toner) section, and the details are omitted here.

### <Mixing Step>

The mixing step is a step of mixing the toner resin particles serving as the toner base particles, and the external additive. At this time, it is preferable to apply a mechanical impact force from the viewpoint that detachment of the external additive particles from the surface of the toner base particles can be restricted.

The methods of applying the mechanical impact force is not limited and can be selected as appropriate according to the intended purpose, and examples include, but are not limited to, a method of applying an impact force to a mixture of the toner resin particles and the external additive using high-speed rotating blades; and a method of introducing a mixture of the toner resin particles and the external additive into a high-speed gas flow, and then accelerating the mixture to cause particles to collide with each other or to cause the particles to collide with an appropriate collision plate.

The device used in the method of applying the mechanical impact force is not limited and can be selected as appropriate according to the intended purpose, and examples include, but are not limited to, an Ong mill (manufactured by Hosokawa Micron Corporation), an I-type mill (manufactured by Nippon Pneumatic Mfg. Co., Ltd.) modified to lower the pulverizing air pressure, a Hybridization System (manufactured by Nara Machinery Co., Ltd.), a Kryptron System (manufactured by Kawasaki Heavy Industries, Ltd.), and an automated mortar.

### <Other Components>

The other components are not limited and can be appropriately selected if preferable. Examples of the other components include, but are not limited to, defoamers (antifoaming agents), pH adjusters, preservatives/fungicides, chelating reagents, rust inhibitors, antioxidants, ultraviolet absorbers, oxygen absorbers, and light stabilizers. These may be used alone as a single type, or in a combination of two or more types.

The content of these other components in the ink is not limited if it does not impair the effects according to embodiments of the present disclosure, and can be selected as appropriate according to the intended purpose.

### (Developer)

The developer according to embodiments of the present disclosure contains at least the toner according to embodiments of the present disclosure and further contains other components such as a carrier that has been appropriately selected, if preferable.

Because the toner contained in the developer according to embodiments of the present disclosure contains the toner resin particles according to embodiments of the present disclosure, the developer exhibits excellent environmental friendliness, charging stability, low-temperature fixability, and heat resistant storage stability. For this reason, the developer has excellent transferability, chargeability, and the like, and can stably form high-quality images.

Note that the developer may be a one-component developer or a two-component developer. However, a two-component developer is preferable when used in high-speed printers corresponding to improvements in information processing speeds in recent years because the service life is improved.

When the developer is used as a one-component developer, even if the balance of the toner is performed, there is little fluctuation in the particle diameter of the toner, there is little filming of the toner on a developing roller, there is little fusion of the toner to members such as a blade for thinning the toner, and good and stable development properties and images can be obtained even during long-term stirring in a developing device.

When the developer is used as a two-component developer, even if the balance of the toner is performed over a long period, there is little fluctuation in the particle diameter of the toner, and good and stable development properties and images can be obtained even during long-term stirring in a developing device.

### <Carrier>

The carrier is not limited and can be selected as appropriate according to the intended purpose. However, the carrier preferably includes a core material and a resin layer covering the core material.

### <<Core Material>>

The material of the core material is not limited and can be selected as appropriate according to the intended purpose, and examples include, but are not limited to, manganese-strontium based materials having a magnetization of 50 emu/g to 90 emu/g and manganese-magnesium based materials of 50 emu/g to 90 emu/g. To ensure image density, it is preferable to use a highly magnetized material such as iron powder having 100 emu/g or more of magnetization and magnetite having 75 emu/g to 120 emu/g of magnetization. In addition, it is preferable to use a weakly magnetized material such as a copper-zinc material having a magnetization of 30 emu/g to 80 emu/g, because it is possible to alleviate the impact of the developer in an upright state on the photoconductor, which has an advantage in that a high image quality can be obtained.

These may be used alone as a single type, or in a combination of two or more types.

The volume average particle diameter of the core material is not limited and can be selected as appropriate according to the intended purpose, but is preferably 10 μm or more and 150 μm or less, and more preferably 40 μm or more and 100 μm or less. When the volume average particle diameter of the core material is 10 μm or more, it is possible to prevent fine powder from increasing in the carrier and to restrict carrier scattering caused by a decrease in magnetization per particle. Also, when the volume average particle diameter of the core material is 150 μm or less, it is possible to prevent the specific surface area from decreasing and to restrict toner scattering, and in full-color images with many solid sections, it is possible to restrict deterioration in the reproduction, particularly in the solid sections.

When the toner is used in a two-component developer, the toner may be used by being mixed with the carrier. The content of the carrier in the two-component developer is not limited and can be selected as appropriate according to the intended purpose, but is preferably 90 parts by mass to 98 parts by mass, and more preferably 93 parts by mass to 97 parts by mass, relative to 100 parts by mass of the two-component developer.

The developer can be used in image formation by various known electrophotographic methods, such as a magnetic single-component developing method, a non-magnetic single-component developing method, or a two-component developing method.

Furthermore, as the developing method, a premix developing method using a premix developer in which toner and carrier are mixed in advance is replenished may be adopted. In the premix developing method, the increased amount of the carrier in the developing device is discharged as excess developer. As a result, the developer in the developing device is gradually refreshed. This makes it possible, for example, to extend the replacement cycle due to deterioration of the developer and to eliminate the effort required to replace the developer.

### (Image Forming Apparatus and Image Forming Method)

The image forming apparatus according to embodiments of the present disclosure includes an electrostatic latent image bearer, an electrostatic latent image forming device that forms an electrostatic latent image on the electrostatic latent image bearer, and a developing device including a toner for developing the electrostatic latent image formed on the electrostatic latent image bearer to form a visible image, and further includes other devices if preferable. The toner in the developing device is the toner according to embodiments of the present disclosure.

### (Image Forming Apparatus)

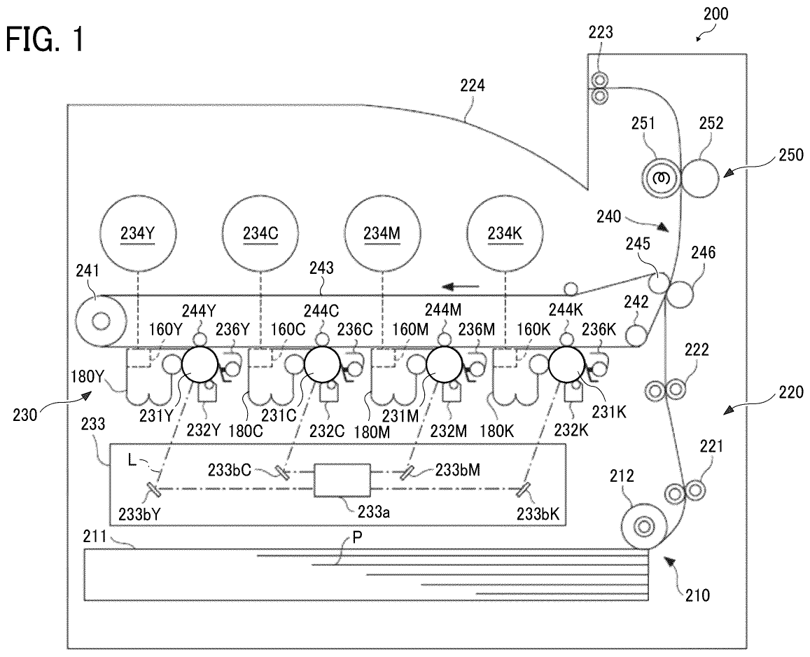

Next, a method of forming an image using an image forming apparatus according to embodiments of the present disclosure is described below with reference to FIG. 1. Although a printer is illustrated as an example of an image forming apparatus of the present embodiment, the image forming apparatus is not limited if the device is capable of forming an image using a toner, such as a copier, a facsimile, or a multifunction peripheral.

An image forming apparatus 200 includes a paper feeding unit 210, a conveyance unit 220, an image formation unit 230, a transfer unit 240, and a fixing device 250.

The paper feeding unit 210 includes a paper feeding cassette 211 in which paper sheets P to be fed are stacked, and a paper feeding roller 212 that feeds the paper sheet P stacked in the paper feeding cassette 211 one sheet at a time.

The conveyance unit 220 includes a roller 221 that conveys the paper sheet P fed by the paper feeding roller 212 toward the transfer unit 240, a pair of timing rollers 222 that hold a front end portion of the paper sheet P conveyed by the roller 221 therebetween and wait to deliver the paper to the transfer unit 240 at a predetermined timing, and a paper discharge roller 223 that discharges the paper sheet P with the color toner image fixed thereto onto a paper discharge tray 224.

The image formation unit 230 includes, from left to right in FIG. 1 at predetermined intervals, an image forming unit 180Y that forms an image using a developer containing yellow toner, an image forming unit 180C that uses a developer containing cyan toner, an image forming unit 180M that uses a developer containing magenta toner, and an image forming unit 180K that uses a developer containing black toner, charging devices 232Y, 232C, 232M, and 232K, and an exposure device 233. The exposure device 233 includes a light source 233a and polygon mirrors 233bY, 233bC, 233bM, and 233bK. Moreover, toner bottles 234Y, 234M, 234C, and 234K, sub-hoppers 160Y, 160M, 160C, and 160K, and cleaning devices 236Y, 236M, 236C, and 236K are also included.

Hereinafter, any of the image forming units (Y, C, M, and K) will be simply referred to as the image forming unit.

Furthermore, the developer contains a toner and a carrier. The four image forming units Y, C, M, and K have substantially the same mechanical configuration except that the developers contained therein are different.

The transfer unit 240 includes a drive roller 241, a driven roller 242, an intermediate transfer belt 243 rotatable counterclockwise in FIG. 1 as the drive roller 241 drives, primary transfer rollers (244Y, 244C, 244M, 244K) arranged opposite the photosensitive drums 231Y, 231C, 231M, and 231K across the intermediate transfer belt 243, and a secondary opposing roller 245 and a secondary transfer roller 246 arranged opposite each other across the intermediate transfer belt 243 at a transfer position of a toner image to paper.

The fixing device 250 includes a fixing belt 251 including an internal heater for heating the paper sheet P, and a pressure roller 252 that rotatably applies a pressure to the fixing belt 251 to form a nip. The color toner image on the sheet P is applied with heat and pressure, and the color toner image is fixed. The paper sheet P on which the color toner image is fixed is discharged onto the paper discharge tray 224 by the paper discharge roller 223, and thus, a series of image forming processes is completed.

### (Developer Containing Unit)

A developer containing unit according to embodiments of the present disclosure refers to a unit containing a developer in a unit having a function of containing a developer. Examples of the developer containing unit include, but are not limited to, a developer container, a developing device, and a process cartridge.

The developer container refers to a container that contains the developer.

The developing device refers to a device that contains the developer and develops images.

The process cartridge refers to a combined body of at least an image bearer and a developing device, which is detachably attached with respect to the image forming apparatus. At least one of a charging device, an irradiation device, or a cleaning device may be integrated with the image bearer and the developing device.

### (Process Cartridge)

A process cartridge according to embodiments of the present disclosure is configured to be detachably mounted on an image forming apparatus, and includes an electrostatic latent image bearer to support an electrostatic latent image, and a developing device to develop the electrostatic latent image into a toner image with the developer according to the present disclosure. The process cartridge may further include other device, if preferable.

The developing device includes at least a developer container containing the developer according to the present disclosure, and a developer carrier to support and convey the developer contained in the developer container. Note that the developing device may further include a regulating member to regulate the thickness of the supported developer.

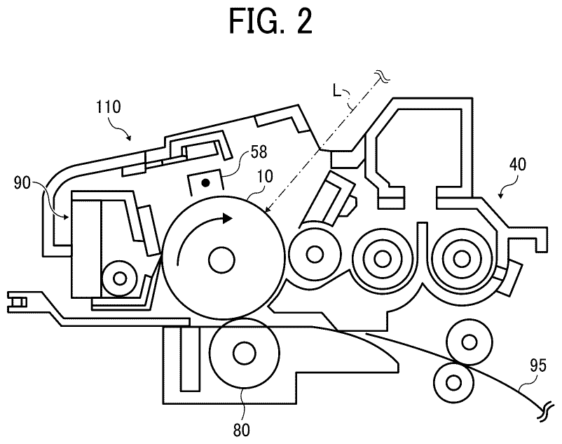

FIG. 2 is a schematic view of a process cartridge according to embodiments of the present disclosure. A process cartridge 110 includes a photoconductor drum 10, a corona charger 58, a developing device 40, a transfer roller 80, and a cleaning device 90. L represents laser light, and 95 represents a paper sheet P.

### EXAMPLES

The present disclosure will be specifically described below with reference to Manufacturing Examples, Examples, and Comparative Examples. However, the present disclosure is not limited to such Manufacturing Examples, Preparation Examples, and Examples. In the Production Examples, Preparation Examples, Examples, and Comparative Examples, unless otherwise indicated, “%” represents “% by mass”, and “parts” represents “parts by mass”. The blending amounts in the Examples and Comparative Examples indicate blending amounts of solid content in each raw material.

### Manufacturing Example A-1: Synthesis of Amorphous Polyester Resin A-1

To a four-neck flask equipped with a nitrogen introduction tube, a dehydration tube, a stirrer, and a thermocouple were charged 497 parts of a bisphenol A 2 mol propylene oxide adduct (manufactured by Sanyo Chemical Industries, Ltd.), 111 parts of recycled PBT (manufactured by Intertek), 300 parts of plant-derived dodecanedioic acid (manufactured by Tokyo Chemical Industry Co., Ltd.), and 91 parts of sodium 5-sulfoisophthalate (manufactured by Tokyo Chemical Industry Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added to the reaction vessel, and the mixture was reacted at 180° C. under normal pressure for 3 hours to obtain [Amorphous Polyester Resin A-1]. The composition and physical property values of the resin are illustrated in Tables 1 and 2 below.

### Manufacturing Example A-2: Synthesis of Amorphous Polyester Resin A-2

To a four-neck flask equipped with a nitrogen introduction tube, a dehydration tube, a stirrer, and a thermocouple were charged 282 parts of a bisphenol A 2 mol ethylene oxide adduct (manufactured by Sanyo Chemical Industries, Ltd.), 297 parts of a bisphenol A 2 mol propylene oxide adduct (manufactured by Sanyo Chemical Industries, Ltd.), 303 parts of adipic acid (manufactured by Hayashi Pure Chemical Ind., Ltd.), and 118 parts of recycled PET (manufactured by Kyoei J&T Environment Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-2]. The composition and physical property values of the resin are illustrated in Tables 1 and 2 below.

### Manufacturing Example A-3: Synthesis of Amorphous Polyester Resin A-3

To a four-neck flask equipped with a nitrogen introduction tube, a dehydration tube, a stirrer, and a thermocouple were charged 576 parts of a bisphenol A 2 mol propylene oxide adduct (manufactured by Sanyo Chemical Industries, Ltd.), 294 parts of adipic acid (manufactured by Hayashi Pure Chemical Ind., Ltd.), and 129 parts of recycled PET (manufactured by Kyoei J&T Environment Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-3]. The composition and physical property values of the resin are illustrated in Tables 1 and 2 below.

### Manufacturing Example A-4: Synthesis of Amorphous Polyester Resin A-4

To a four-neck flask equipped with a nitrogen introduction tube, a dehydration tube, a stirrer, and a thermocouple were charged 499 parts of a bisphenol A 2 mol propylene oxide adduct (manufactured by Sanyo Chemical Industries, Ltd.), 401 parts of plant-derived dodecanedioic acid (manufactured by Tokyo Chemical Industry Co., Ltd.), and 99 parts of recycled PET (manufactured by Kyoei J&T Environment Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-4]. The composition and physical property values of the resin are illustrated in Tables 1 and 2 below.

### Manufacturing Example A-5: Synthesis of Amorphous Polyester Resin A-5

To a four-neck flask equipped with a nitrogen introduction tube, a dehydration tube, a stirrer, and a thermocouple were charged 592 parts of a bisphenol A 2 mol propylene oxide adduct (manufactured by Sanyo Chemical Industries, Ltd.), 242 parts of adipic acid (manufactured by Hayashi Pure Chemical Ind., Ltd.), 49 parts of plant-derived succinic acid (manufactured by Tokyo Chemical Industry Co., Ltd.), and 118 parts of recycled PET (manufactured by Kyoei J&T Environment Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-5]. The composition and physical property values of the resin are illustrated in Tables 1 and 2 below.

### Manufacturing Example A-6: Synthesis of Amorphous Polyester Resin A-6

To a four-neck flask equipped with a nitrogen introduction tube, a dehydration tube, a stirrer, and a thermocouple were charged 549 parts of a bisphenol A 2 mol propylene oxide adduct (manufactured by Sanyo Chemical Industries, Ltd.), 280 parts of adipic acid (manufactured by Hayashi Pure Chemical Ind., Ltd.), and 170 parts of recycled PET (manufactured by Kyoei J&T Environment Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-6]. The composition and physical property values of the resin are illustrated in Tables 1 and 2 below.

### Manufacturing Example A-7: Synthesis of Amorphous Polyester Resin A-7

To a four-neck flask equipped with a nitrogen introduction tube, a dehydration tube, a stirrer, and a thermocouple were charged 254 parts of a bisphenol A 2 mol ethylene oxide adduct (manufactured by Sanyo Chemical Industries, Ltd.), 268 parts of a bisphenol A 2 mol propylene oxide adduct (manufactured by Sanyo Chemical Industries, Ltd.), 102 parts of adipic acid (manufactured by Hayashi Pure Chemical Ind., Ltd.), 107 parts of recycled PET (manufactured by Kyoei J&T Environment Co., Ltd.), and 269 parts of plant-derived dodecanedioic acid (manufactured by Tokyo Chemical Industry Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-7].

The composition and physical property values of the resin are illustrated in Tables 1 and 2 below.

### Manufacturing Example A-8: Synthesis of Amorphous Polyester Resin A-8

To a four-neck flask equipped with a nitrogen introduction tube, a dehydration tube, a stirrer, and a thermocouple were charged 376 parts of a bisphenol A 2 mol ethylene oxide adduct (manufactured by Sanyo Chemical Industries, Ltd.), 264 parts of a bisphenol A 2 mol propylene oxide adduct (manufactured by Sanyo Chemical Industries, Ltd.), 168 parts of adipic acid (manufactured by Hayashi Pure Chemical Ind., Ltd.), and 191 parts of terephthalic acid (manufactured by Toray Industries, Inc.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-8]. The composition and physical property values of the resin are illustrated in Tables 1 and 2 below.

### Manufacturing Example A-9: Synthesis of Amorphous Polyester Resin A-9

To a four-neck flask equipped with a nitrogen introduction tube, a dehydration tube, a stirrer, and a thermocouple were charged 45 parts of plant-derived 1,3-butanediol (manufactured by Daicel Corporation), 31 parts of plant-derived ethylene glycol, 429 parts of a bisphenol A 2 mol propylene oxide adduct (manufactured by Sanyo Chemical Industries, Ltd.), 207 parts of plant-derived terephthalic acid (manufactured by Idemitsu Kosan Co., Ltd.), and 288 parts of plant-derived dodecanedioic acid (manufactured by Tokyo Chemical Industry Co., Ltd.). The mixture was reacted with titanium tetraisopropoxide (500 ppm relative to the resin component) at 230° C. under normal pressure for 8 hours, and further reacted under a reduced pressure of 10 mmHg to 15 mmHg for 4 hours. Then, 5 parts of trimellitic anhydride was added into the reaction vessel, and the mixture was reacted at 180° C. under normal pressure for 3 hours to obtain [Amorphous Polyester Resin A-9]. The composition and physical property values of the resin are illustrated in Table 1 below.

Furthermore, the weight average molecular weight and glass transition temperature Tg of each resin are illustrated in Table 2.

TABLE 1

| Amorphous | | | | | | |
|---|---|---|---|---|---|---|
| Polyester | | | | | | |
| Resin A | Monomer Type | | | | | |
| No. | Alcohol Monomer | | | Acid Monomer | | |
| A-1 | Bis-A-PO | PBT-derived | | Plant-derived | PET-derived | Sulfoiso- |
| | | 1,4- | | dodecanedioic | terephthalic | phthalic acid |
| | | propanediol | | acid | acid | sodium salt |
| A-2 | Bis-A-EO | Bis-A-PO | PET- | Adipic acid | PET-derived | |
| | | | derived | | terephthalic | |
| | | | ethylene | | acid | |
| | | | glycol | | | |
| A-3 | Bis-A-PO | PET-derived | | Adipic acid | PET-derived | |
| | | ethylene | | | terephthalic | |
| | | glycol | | | acid | |
| A-4 | Bis-A-PO | Plant- | | Plant-derived | Plant-derived | |
| | | derived | | dodecanedioic | terephthalic | |
| | | ethylene | | acid | acid | |
| | | glycol | | | | |
| A-5 | Bis-A-PO | PET-derived | | Adipic acid | PET-derived | Plant-derived |
| | | ethylene | | | terephthalic | succinic acid |
| | | glycol | | | acid | |
| A-6 | Bis-A-PO | PET-derived | | Adipic acid | PET-derived | |
| | | ethylene | | | terephthalic | |
| | | glycol | | | acid | |
| A-7 | Bis-A-EO | Bis-A-PO | PET-derived | Adipic acid | PET-derived | Plant-derived |
| | | | ethylene | | terephthalic | dodecanedioic |
| | | | glycol | | acid | acid |
| A-8 | Bis-A-EO | Bis-A-PO | | Adipic acid | Terephthalic | |
| | | | | | acid | |
| A-9 | Plant- | Plant- | Bis-A-PO | Plant-derived | Plant-derived | |
| | derived | derived | | terephthalic | dodecanedioic | |
| | 1,3- | ethylene | | acid | acid | |
| | butanediol | glycol | | | | |

| | | | | | | | Environ- | |
|---|---|---|---|---|---|---|---|---|
| Amorphous | | | | | | | mentally | |
| Polyester | | | | | | | Friendly | |
| Resin A | Parts Added | | | | | | Component | SP Value |
| No. | Alcohol | | | Acid | | | Ratio [%] | [(cal/cm³)^{1/2}] |
| A-1 | 497 | 39 | | 300 | 72 | 91 | 41 | 11.3 |
| A-2 | 282 | 297 | 32 | 303 | 86 | | 12 | 11.4 |
| A-3 | 576 | 35 | | 294 | 94 | | 13 | 11.4 |
| A-4 | 499 | 27 | | 401 | 72 | | 50 | 11.0 |
| A-5 | 592 | 32 | | 242 | 86 | 49 | 12 | 11.4 |
| A-6 | 549 | 46 | | 280 | 124 | | 17 | 11.6 |
| A-7 | 254 | 268 | 29 | 102 | 78 | 269 | 11 | 11.2 |
| A-8 | 376 | 264 | | 168 | 191 | | 0 | 11.2 |
| A-9 | 45 | 31 | 429 | 207 | 288 | | 57 | 11.6 |

TABLE 2

| Amorphous Polyester | Weight Average | |
|---|---|---|
| Resin A No. | Molecular Weight | Tg[° C.] |
| A-1 | 9600 | 55 |
| A-2 | 9800 | 58 |
| A-3 | 10000 | 57 |
| A-4 | 9900 | 54 |
| A-5 | 9500 | 59 |
| A-6 | 9400 | 58 |
| A-7 | 9300 | 53 |
| A-8 | 9700 | 54 |
| A-9 | 9800 | 55 |

### Manufacturing Example B-1: Synthesis of Amorphous Polyester Resin B-1

To a four-neck flask equipped with a nitrogen introduction tube, a dehydration tube, a stirrer, and a thermocouple were charged 45 parts of plant-derived 1,3-butanediol (manufactured by Daicel Corporation), 31 parts of plant-derived ethylene glycol, 429 parts of a bisphenol A 2 mol propylene oxide adduct (manufactured by Sanyo Chemical Industries, Ltd.), 207 parts of plant-derived terephthalic acid (manufactured by Idemitsu Kosan Co., Ltd.), and 288 parts of plant-derived dodecanedioic acid (manufactured by Tokyo Chemical Industry Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-1]. The composition and physical property values of the resin are illustrated in Tables 3 and 4 below.

### Manufacturing Example B-2: Synthesis of Amorphous Polyester Resin B-2

To a four-neck flask equipped with a nitrogen introduction tube, a dehydration tube, a stirrer, and a thermocouple were charged 458 parts of a bisphenol A 2 mol propylene oxide adduct (manufactured by Sanyo Chemical Industries, Ltd.), 316 parts of plant-derived dodecanedioic acid (manufactured by Tokyo Chemical Industry Co., Ltd.), 69 parts of plant-derived abietic acid (manufactured by Tokyo Chemical Industry Co., Ltd.), and 157 parts of recycled PET (manufactured by Kyoei J&T Environment Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-2]. The composition and physical property values of the resin are illustrated in Tables 3 and 4 below.

### Manufacturing Example B-3: Synthesis of Amorphous Polyester Resin B-3

To a four-neck flask equipped with a nitrogen introduction tube, a dehydration tube, a stirrer, and a thermocouple were charged 557 parts of a bisphenol A 2 mol ethylene oxide adduct (manufactured by Sanyo Chemical Industries, Ltd.), 146 parts of a bisphenol A 2 mol propylene oxide adduct (manufactured by Sanyo Chemical Industries, Ltd.), 85 parts of isophthalic acid (manufactured by manufactured by Mitsubishi Gas Chemical Company, Inc.), and 212 parts of terephthalic acid (manufactured by Toray Industries, Inc.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-3]. The composition and physical property values of the resin are illustrated in Tables 3 and 4 below.

### Manufacturing Example B-4: Synthesis of Amorphous Polyester Resin B-4

To a four-neck flask equipped with a nitrogen introduction tube, a dehydration tube, a stirrer, and a thermocouple were charged 497 parts of a bisphenol A 2 mol propylene oxide adduct (manufactured by Sanyo Chemical Industries, Ltd.), 111 parts of recycled PBT (manufactured by Intertek), 300 parts of plant-derived dodecanedioic acid (manufactured by Tokyo Chemical Industry Co., Ltd.), and 91 parts of sodium 5-sulfoisophthalate (manufactured by Tokyo Chemical Industry Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added to the reaction vessel, and the mixture was reacted at 180° C. under normal pressure for 3 hours to obtain [Amorphous Polyester Resin B-4]. The composition and physical property values of the resin are illustrated in Tables 3 and 4 below.

### Manufacturing Example B-5: Synthesis of Amorphous Polyester Resin B-5

To a four-neck flask equipped with a nitrogen introduction tube, a dehydration tube, a stirrer, and a thermocouple were charged 327 parts of a bisphenol A 2 mol ethylene oxide adduct (manufactured by Sanyo Chemical Industries, Ltd.), 344 parts of a bisphenol A 2 mol propylene oxide adduct (manufactured by Sanyo Chemical Industries, Ltd.), 80 parts of isophthalic acid (manufactured by manufactured by Mitsubishi Gas Chemical Company, Inc.), 80 parts of terephthalic acid (manufactured by Toray Industries, Inc.), and 170 parts of plant-derived succinic acid (manufactured by Tokyo Chemical Industry Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-5]. The composition and physical property values of the resin are illustrated in Tables 3 and 4 below.

### Manufacturing Example B-6: Synthesis of Amorphous Polyester Resin B-6

To a four-neck flask equipped with a nitrogen introduction tube, a dehydration tube, a stirrer, and a thermocouple were charged 493 parts of a bisphenol A 2 mol propylene oxide adduct (manufactured by Sanyo Chemical Industries, Ltd.), 116 parts of plant-derived succinic acid (manufactured by Tokyo Chemical Industry Co., Ltd.), 223 parts of plant-derived abietic acid (manufactured by Tokyo Chemical Industry Co., Ltd.), and 168 parts of recycled PET (manufactured by Kyoei J&T Environment Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-6]. The composition and physical property values of the resin are illustrated in Tables 3 and 4 below.

### Manufacturing Example B-7: Synthesis of Amorphous Polyester Resin B-7

To a four-neck flask equipped with a nitrogen introduction tube, a dehydration tube, a stirrer, and a thermocouple were charged 576 parts of a bisphenol A 2 mol propylene oxide adduct (manufactured by Sanyo Chemical Industries, Ltd.), 294 parts of adipic acid (manufactured by Hayashi Pure Chemical Ind., Ltd.), and 129 parts of recycled PET (manufactured by Kyoei J&T Environment Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-7]. The composition and physical property values of the resin are illustrated in Tables 3 and 4 below.

### Manufacturing Example B-8: Synthesis of Amorphous Polyester Resin B-8

To a four-neck flask equipped with a nitrogen introduction tube, a dehydration tube, a stirrer, and a thermocouple were charged 592 parts of a bisphenol A 2 mol propylene oxide adduct (manufactured by Sanyo Chemical Industries, Ltd.), 242 parts of adipic acid (manufactured by Hayashi Pure Chemical Ind., Ltd.), 49 parts of plant-derived succinic acid (manufactured by Tokyo Chemical Industry Co., Ltd.), and 118 parts of recycled PET (manufactured by Kyoei J&T Environment Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-8]. The composition and physical property values of the resin are illustrated in Tables 3 and 4 below.

### Manufacturing Example B-9: Synthesis of Amorphous Polyester Resin B-9

To a four-neck flask equipped with a nitrogen introduction tube, a dehydration tube, a stirrer, and a thermocouple were charged 376 parts of a bisphenol A 2 mol ethylene oxide adduct (manufactured by Sanyo Chemical Industries, Ltd.), 264 parts of a bisphenol A 2 mol propylene oxide adduct (manufactured by Sanyo Chemical Industries, Ltd.), 168 parts of adipic acid (manufactured by Hayashi Pure Chemical Ind., Ltd.), and 191 parts of terephthalic acid (manufactured by Toray Industries, Inc.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-9]. The composition and physical property values of the resin are illustrated in Tables 3 and 4 below.

### Manufacturing Example B-10: Synthesis of Amorphous Polyester Resin B-10

To a four-neck flask equipped with a nitrogen introduction tube, a dehydration tube, a stirrer, and a thermocouple were charged 33 parts of plant-derived 1,3-butanediol (manufactured by Daicel Corporation), 574 parts of a bisphenol A 2 mol propylene oxide adduct (manufactured by Sanyo Chemical Industries, Ltd.), 243 parts of plant-derived succinic acid (manufactured by Tokyo Chemical Industry Co., Ltd.), 87 parts of plant-derived dodecanedioic acid (manufactured by Tokyo Chemical Industry Co., Ltd.), and 62 parts of recycled PET (manufactured by Kyoei J&T Environment Co., Ltd.). The mixture was reacted with titanium tetraisopropoxide (500 ppm relative to the resin component) at 230° C. under normal pressure for 10 hours, and further reacted under a reduced pressure of 10 mmHg to 15 mmHg for 6 hours. Then, 5 parts of trimellitic anhydride was added into the reaction vessel, and the mixture was reacted at 180° C. under normal pressure for 3 hours to obtain [Amorphous Polyester Resin B-10]. The composition and physical property values of the resin are illustrated in Tables 3 and 4 below.

TABLE 3

| Amorphous | | | | | | |
|---|---|---|---|---|---|---|
| Polyester | | | | | | |
| Resin B | Monomer Type | | | | | |
| No. | Alcohol | | | Acid | | |
| B-1 | Plant- | Plant-derived | Bis-A-PO | Plant-derived | Plant-derived | |
| | derived 1,3- | ethylene | | terephthalic | dodecanedioic | |
| | butanediol | glycol | | acid | acid | |
| B-2 | PET-derived | Bis-A-PO | | PET-derived | Plant-derived | Plant-derived |
| | ethylene | | | terephthalic | dodecanedioic | abietic acid |
| | glycol | | | acid | acid | |
| B-3 | Bis-A-EO | Bis-A-PO | | Isophthalic | Terephthalic | |
| | | | | acid | acid | |
| B-4 | Bis-A-PO | PBT-derived | | Plant-derived | PBT-derived | Sulfoiso- |
| | | 1,4- | | dodecanedioic | terephthalic | phthalic acid |
| | | propanediol | | acid | acid | sodium salt |
| B-5 | Bis-A-EO | Bis-A-PO | | Isophthalic | Terephthalic | Plant-derived |
| | | | | acid | acid | succinic acid |
| B-6 | PET-derived | Bis-A-PO | | PET-derived | Plant-derived | Plant-derived |
| | ethylene | | | terephthalic | succinic acid | abietic acid |
| | glycol | | | acid | | |
| B-7 | Bis-A-PO | PET-derived | | Adipic acid | PET-derived | |
| | | ethylene | | | terephthalic | |
| | | glycol | | | acid | |
| B-8 | Bis-A-PO | PET-derived | | Adipic acid | PET-derived | Plant-derived |
| | | ethylene | | | terephthalic | succinic acid |
| | | glycol | | | acid | |
| B-9 | Bis-A-EO | Bis-A-PO | | Adipic acid | Terephthalic | |
| | | | | | acid | |
| B-10 | Plant- | PET-derived | Bis-A-PO | PET-derived | Plant-derived | Plant-derived |
| | derived 1,3- | ethylene | | terephthalic | succinic acid | dodecanedioic |
| | butanediol | glycol | | acid | | acid |

| | | | | | | | Environ- | |
|---|---|---|---|---|---|---|---|---|
| Amorphous | | | | | | | mentally | |
| Polyester | | | | | | | Friendly | |
| Resin B | Parts Added | | | | | | Component | SP Value |
| No. | Alcohol | | | Acid | | | Ratio [%] | [(cal/cm³)^{1/2}] |
| B-1 | 45 | 31 | 429 | 207 | 288 | | 57 | 11.6 |
| B-2 | 43 | 458 | | 114 | 316 | 69 | 54 | 11.5 |
| B-3 | 557 | 146 | | 85 | 212 | | 0 | 11.6 |
| B-4 | 497 | 39 | | 300 | 72 | 91 | 41 | 11.3 |
| B-5 | 327 | 344 | | 80 | 80 | 170 | 17 | 11.5 |
| B-6 | 46 | 493 | | 122 | 116 | 223 | 51 | 12.5 |
| B-7 | 576 | 35 | | 294 | 94 | | 13 | 11.4 |
| B-8 | 592 | 32 | | 242 | 86 | 49 | 12 | 11.4 |
| B-9 | 376 | 264 | | 168 | 191 | | 0 | 11.2 |
| B-10 | 33 | 17 | 574 | 45 | 243 | 87 | 43 | 11.7 |

TABLE 4

| Amorphous Polyester | Weight Average | |
|---|---|---|
| Resin B No. | Molecular Weight | Tg[° C.] |
| B-1 | 10800 | 61 |
| B-2 | 10700 | 62 |
| B-3 | 11000 | 63 |
| B-4 | 10600 | 61 |
| B-5 | 10800 | 60 |
| B-6 | 10900 | 65 |
| B-7 | 11000 | 63 |
| B-8 | 10500 | 64 |
| B-9 | 10700 | 60 |
| B-10 | 10600 | 62 |

### Preparation Example 1-1: Preparation of Amorphous Polyester Resin B Dispersion Liquid 1

To a 500 mL separable flask were added 150 parts of [Amorphous Polyester Resin B-1], 150 parts of methyl ethyl ketone, and 0.1 parts of sodium hydroxide (0.3 N), and the mixture was stirred using a three-one motor (manufactured by Shinto Scientific Co., Ltd.) to prepare a resin mixture. While further stirring the resin mixture, 700 parts of ion-exchanged water was gradually added to perform phase inversion emulsification, and the solvent was removed to obtain [Amorphous Polyester Resin B Dispersion Liquid 1]. The volume average particle size of the resin particles in the obtained [Amorphous Polyester Resin B Dispersion Liquid 1] was 50 nm, and the solid content concentration was 25%. The composition and physical properties of the dispersion liquid are illustrated in Table 5.

### Preparation Example 1-2: Preparation of Amorphous Polyester Resin B Dispersion Liquid 2

[Amorphous Polyester Resin B Dispersion Liquid 2] was obtained by the same method as in Preparation Example 1-1, except that in Preparation Example 1-1, [Amorphous Polyester Resin B-1] was changed to [Amorphous Polyester Resin B-2]. The volume average particle size of the resin particles in the obtained [Amorphous Polyester Resin B Dispersion Liquid 2] was 62 nm, and the solid content concentration was 25%. The composition and physical properties of the dispersion liquid are illustrated in Table 5.

### Preparation Example 1-3: Preparation of Amorphous Polyester Resin B Dispersion Liquid 3

[Amorphous Polyester Resin B Dispersion Liquid 3] was obtained by the same method as in Preparation Example 1-1, except that in Preparation Example 1-1, [Amorphous Polyester Resin B-1] was changed to [Amorphous Polyester Resin B-3]. The volume average particle size of the resin particles in the obtained [Amorphous Polyester Resin B Dispersion Liquid 3] was 45 nm, and the solid content concentration was 25%. The composition and physical properties of the dispersion liquid are illustrated in Table 5.

### Preparation Example 1-4: Preparation of Amorphous Polyester Resin B Dispersion Liquid 4

[Amorphous Polyester Resin B Dispersion Liquid 4] was obtained by the same method as in Preparation Example 1-1, except that in Preparation Example 1-1, [Amorphous Polyester Resin B-1] was changed to [Amorphous Polyester Resin B-4]. The volume average particle size of the resin particles in the obtained [Amorphous Polyester Resin B Dispersion Liquid 4] was 40 nm, and the solid content concentration was 25%. The composition and physical properties of the dispersion liquid are illustrated in Table 5.

### Preparation Example 1-5: Preparation of Amorphous Polyester Resin B Dispersion Liquid 5

[Amorphous Polyester Resin B Dispersion Liquid 5] was obtained by the same method as in Preparation Example 1-1, except that in Preparation Example 1-1, [Amorphous Polyester Resin B-1] was changed to [Amorphous Polyester Resin B-5]. The volume average particle size of the resin particles in the obtained [Amorphous Polyester Resin B Dispersion Liquid 5] was 40 nm, and the solid content concentration was 25%. The composition and physical properties of the dispersion liquid are illustrated in Table 5.

### Preparation Example 1-6: Preparation of Amorphous Polyester Resin B Dispersion Liquid 6

[Amorphous Polyester Resin B Dispersion Liquid 6] was obtained by the same method as in Preparation Example 1-1, except that in Preparation Example 1-1, [Amorphous Polyester Resin B-1] was changed to [Amorphous Polyester Resin B-6]. The volume average particle size of the resin particles in the obtained [Amorphous Polyester Resin B Dispersion Liquid 6] was 45 nm, and the solid content concentration was 25%. The composition and physical properties of the dispersion liquid are illustrated in Table 5.

### Preparation Example 1-7: Preparation of Amorphous Polyester Resin B Dispersion Liquid 7

[Amorphous Polyester Resin B Dispersion Liquid 7] was obtained by the same method as in Preparation Example 1-1, except that in Preparation Example 1-1, [Amorphous Polyester Resin B-1] was changed to [Amorphous Polyester Resin B-7]. The volume average particle size of the resin particles in the obtained [Amorphous Polyester Resin B Dispersion Liquid 7] was 75 nm, and the solid content concentration was 25%. The composition and physical properties of the dispersion liquid are illustrated in Table 5.

### Preparation Example 1-8: Preparation of Amorphous Polyester Resin B Dispersion Liquid 8

[Amorphous Polyester Resin B Dispersion Liquid 8] was obtained by the same method as in Preparation Example 1-1, except that in Preparation Example 1-1, [Amorphous Polyester Resin B-1] was changed to [Amorphous Polyester Resin B-8]. The volume average particle size of the resin particles in the obtained [Amorphous Polyester Resin B Dispersion Liquid 8] was 64 nm, and the solid content concentration was 25%. The composition and physical properties of the dispersion liquid are illustrated in Table 5.

### Preparation Example 1-9: Preparation of Amorphous Polyester Resin B Dispersion Liquid 9

[Amorphous Polyester Resin B Dispersion Liquid 9] was obtained by the same method as in Preparation Example 1-1, except that in Preparation Example 1-1, [Amorphous Polyester Resin B-1] was changed to [Amorphous Polyester Resin B-9]. The volume average particle size of the resin particles in the obtained [Amorphous Polyester Resin B Dispersion Liquid 9] was 70 nm, and the solid content concentration was 25%. The composition and physical properties of the dispersion liquid are illustrated in Table 5.

### Preparation Example 1-10: Preparation of Amorphous Polyester Resin B Dispersion Liquid 10

[Amorphous Polyester Resin B Dispersion Liquid 10] was obtained by the same method as in Preparation Example 1-1, except that in Preparation Example 1-1, [Amorphous Polyester Resin B-1] was changed to [Amorphous Polyester Resin B-10]. The volume average particle size of the resin particles in the obtained [Amorphous Polyester Resin B Dispersion Liquid 10] was 48 nm, and the solid content concentration was 25%. The composition and physical properties of the dispersion liquid are illustrated in Table 5.

The amorphous polyester resin B dispersion liquids obtained in Preparation Examples 1-1 to 1-10 are summarized in Table 5 below.

TABLE 5

| | | Amorphous | Volume Average | |
|---|---|---|---|---|
| | | Polyester | Particle Size | Solid Conent |
| | Type | Resin B No. | [nm] | [% by mass] |
| Amorphous | 1 | B-1 | 50 | 25 |
| Polyester Resin | 2 | B-2 | 62 | 25 |
| Dispersion | 3 | B-3 | 45 | 25 |
| Liquid | 4 | B-4 | 40 | 25 |
| | 5 | B-5 | 40 | 25 |
| | 6 | B-6 | 45 | 25 |
| | 7 | B-7 | 75 | 25 |
| | 8 | B-8 | 64 | 25 |
| | 9 | B-9 | 70 | 25 |
| | 10 | B-10 | 48 | 25 |

### Manufacturing Example C-1: Synthesis of Crystalline Polyester Resin C-1

To a 5-L four-neck flask equipped with a nitrogen introduction tube, a dehydration tube, a stirrer, and a thermocouple were charged plant-derived sebacic acid (manufactured by Ogura Synthetic Industries Co., Ltd.) and plant-derived ethylene glycol (manufactured by India Glycols Ltd) such that [OH/COOH], which represents the molar ratio of hydroxyl groups to carboxyl groups, was 0.9. The mixture was reacted with titanium tetraisopropoxide (500 ppm relative to the resin component) at 180° C. for 10 hours, and then heated to 200° C. and reacted for 3 hours, and further reacted at a pressure of 8.3 kPa for 2 hours to obtain [Crystalline Polyester Resin C-1]. The physical property values of the resin are illustrated in Table 6 below.

### Manufacturing Example C-2: Synthesis of Crystalline Polyester Resin C-2

[Crystalline Polyester Resin C-2] was obtained in the same manner as in Manufacturing Example C-1, except that in Manufacturing Example C-1, plant-derived ethylene glycol as the diol component was changed to 1,6-hexanediol (manufactured by Tokyo Chemical Industry Co., Ltd.). The physical property values of the resin are illustrated in Table 6 below.

### Manufacturing Example C-3: Synthesis of Crystalline Polyester Resin C-3

[Crystalline Polyester Resin C-3] was obtained in the same manner as in Manufacturing Example C-1, except that in Manufacturing Example C-1, plant-derived ethylene glycol as the dicarboxylic acid component was changed to plant-derived dodecanedioic acid (manufactured by Tokyo Chemical Industry Co., Ltd.). The physical property values of the resin are illustrated in Table 6 below.

TABLE 6

| | | | Environmentally | | | |
|---|---|---|---|---|---|---|
| Crystalline | | | Friendly | | | |
| Polyester | Monomer Type | | Component | SP Value | | Tm |
| Resin C No. | Alcohol | Acid | Ratio [%] | [(cal/cm³)^{1/2}] | Mw | [° C.] |
| C-1 | Plant-derived ethylene glycol | Plant-derived sebacic acid | 100 | 10.3 | 20000 | 72 |
| C-2 | 1,6-hexanediol | Plant-derived sebacic acid | 67 | 10.0 | 23000 | 62 |
| C-3 | 1,6-hexanediol | Plant-derived dodecanedioic | 63 | 9.8 | 18000 | 80 |
| | | acid | | | | |

### Preparation Example 2-1: Preparation of Crystalline Polyester Resin C Dispersion Liquid 1

To a vessel equipped with a stirring rod and a thermometer were charged 45 parts of [Crystalline Polyester Resin C-1] and 450 parts of ethyl acetate. The mixture was heated to 80° C. under stirring, kept at 80° C. for 5 hours, and then cooled to 30° C. over 1 hour. Then, dispersion was performed using a bead mill (ULTRAVISCOMILL, manufactured by Aimex Co., Ltd.) under the conditions of a liquid feeding speed of 1 kg/hour, a disk peripheral speed of 6 m/second, 0.5 mm diameter zirconia beads filled to 80% by volume, and 3 passes to obtain [Crystalline Polyester Resin C Dispersion Liquid 1]. The volume average particle size of the obtained crystalline polyester resin particles was 350 nm, and the solid content concentration of the resin particles was 10%. The composition and physical properties of the dispersion liquid are illustrated in Table 7.

### Preparation Example 2-2: Preparation of Crystalline Polyester Resin C Dispersion Liquid 2

[Crystalline Polyester Resin C Dispersion Liquid 2] was obtained by the same method as in Preparation Example 2-1, except that in Preparation Example 2-1, [Crystalline Polyester Resin C-1] was changed to [Crystalline Polyester Resin C-2]. The volume average particle size of the obtained crystalline polyester resin particles was 350 nm, and the solid content concentration of the resin particles was 10%. The composition and physical properties of the dispersion liquid are illustrated in Table 7.

### Preparation Example 2-3: Preparation of Crystalline Polyester Resin C Dispersion Liquid 3

[Crystalline Polyester Resin C Dispersion Liquid 3] was obtained by the same method as in Preparation Example 2-1, except that in Preparation Example 2-1, [Crystalline Polyester Resin C-1] was changed to [Crystalline Polyester Resin C-3]. The volume average particle size of the resin particles in the obtained [Crystalline Polyester Resin C Dispersion Liquid 3] was 360 nm, and the solid content concentration was 10%. The composition and physical properties of the dispersion liquid are illustrated in Table 7.

The crystalline polyester resin C dispersion liquids obtained in Preparation Example 2-1 to Preparation Example 2-3 are summarized in Table 7 below.

TABLE 7

| Crystalline Polyester Resin C | Crystalline | Volume Average | Solid Content |
|---|---|---|---|
| Dispersion Liquid Type | Polyester Resin | Particle Size [nm] | [% by mass] |
| Crystalline polyester resin C | Crystalline | 350 | 10 |
| dispersion liquid 1 | polyester resin C-1 | | |
| Crystalline polyester resin C | Crystalline | 350 | 10 |
| dispersion liquid 2 | polyester resin C-2 | | |
| Crystalline polyester resin C | Crystalline | 360 | 10 |
| dispersion liquid 3 | polyester resin C-3 | | |

### Preparation Example 3-1: Preparation of Masterbatch 1

A mixture of 500 parts of water, 500 parts of carbon black (PRINTEX 35, manufactured by Degussa AG) [DBP oil absorption amount=42 mL/100 mg, pH=9.5], and 500 parts of [Amorphous Polyester Resin A-9] was added and mixed in a Henschel mixer (manufactured by Nippon Coke & Engineering Co., Ltd.). The mixture was kneaded using two rolls at 150° C. for 30 minutes, and then rolled and cooled, and pulverized in a pulverizer to obtain [Masterbatch 1]. The configuration is illustrated in Table 8 below.

### Preparation Example 3-2: Preparation of Masterbatch 2

[Masterbatch 2] was obtained by the same method as in Preparation Example 3-1, except that in Preparation Example 3-1, [Amorphous Polyester Resin A-9] was changed to [Amorphous Polyester Resin A-4]. The configuration is illustrated in Table 8 below.

The masterbatches obtained in Preparation Example 3-1 and Preparation Example 3-2 are summarized in Table 8 below.

TABLE 8

| | Pigment | | | |
|---|---|---|---|---|
| | (Carbon | Resin | | Environmentally |
| | Black) | | [parts | Friendly |
| Masterbatch | [parts | | by | Component |
| No. | by mass] | Type | mass] | Ratio [% by mass] |
| Masterbatch 1 | 500 | Amorphous | 500 | 29 |
| | | polyester | | |
| | | resin A-9 | | |
| Masterbatch 2 | 500 | Amorphous | 500 | 25 |
| | | polyester | | |
| | | resin A-4 | | |

### Preparation Example 4-1: Preparation of Wax Dispersion Liquid 1

To a container equipped with a stirring rod and a thermometer was charged 50 parts of ester wax (WE-11, manufactured by NOF Corporation, synthetic wax of plant-derived monomer, melting point 70° C.) and 450 parts of ethyl acetate. Then, the temperature was raised to 80° C. while stirring, and after holding the temperature at 80° C. for 5 hours, the mixture was cooled to 30° C. over 1 hour. Further, dispersion was performed using a bead mill (Ultra Visco Mill, manufactured by AIMEX Co., Ltd.) under conditions of a liquid feed rate of 1 kg/hour, a disk peripheral speed of 6 m/second, 80% by volume filling with 0.5 mm diameter zirconia beads, and 3 passes to obtain [Wax Dispersion Liquid 1]. The volume average particle diameter of the wax particles in the obtained [Wax Dispersion Liquid 1] was 420 nm, and the solid content concentration of the resin particles was 25%. The composition and physical properties are illustrated in Table 9.

### Preparation Example 4-2: Preparation of Wax Dispersion Liquid 2

[Wax Dispersion Liquid 2] was obtained in the same manner as in Preparation Example 4-1, except that in Preparation Example 4-1, the ester wax was changed to paraffin wax (HNP-9, manufactured by Nippon Seiro Co., Ltd., hydrocarbon-based wax, melting point 75° C.). The volume average particle diameter of the wax particles in the obtained [Wax Dispersion Liquid 2] was 480 nm, and the solid content concentration of the resin particles was 25%. The composition and physical properties are illustrated in Table 9.

The wax dispersion liquids obtained in Preparation Example 4-1 and Preparation Example 4-2 are summarized in Table 9 below.

TABLE 9

| | | Environmentally | | |
|---|---|---|---|---|
| Wax Dispersion | | Friendly Component | Volume Average | Solid Content |
| Liquid Type | Wax Type | Ratio of Wax [%] | Particle Size [nm] | [% by mass] |
| Wax dispersion | Ester wax | 100 | 420 | 10 |
| liquid 1 | (Synthetic wax | | | |
| | of plant-derived | | | |
| | monomer) | | | |
| Wax dispersion | Paraffin wax | 0 | 480 | 10 |
| liquid 2 | | | | |

### Example 1

### <Preparation of Oil Phase>

To a container was added 50 parts of [Wax Dispersion Liquid 1], 670 parts of [Amorphous Polyester Resin A-1], 50 parts of [Crystalline Polyester Resin C Dispersion Liquid 1], and 90 parts of [Masterbatch 1] (pigment), and the mixture was mixed at 7,000 rpm for 60 minutes using a TK Homomixer (manufactured by Primix Corporation) to obtain [Oil Phase 1].

Note that the blending amount of each component indicates the blending amount of the solid content in each raw material, and the same applies to the following steps.

### <Preparation of Aqueous Phase>

A mixture of 990 parts of water, 25 parts of sodium dodecyl sulfate, and 90 parts of ethyl acetate was mixed and stirred to obtain a milky white liquid. The liquid was designated as [Aqueous Phase 1].

### <Phase Inversion Emulsification>

While stirring 700 parts of [Oil Phase 1] with a TK Homomixer at a rotation speed of 5,000 rpm, 20 parts of 28% ammonia water was added thereto and mixed for 10 minutes, and then 1,200 parts of [Aqueous Phase 1] was gradually added dropwise to obtain [Emulsification Slurry 1].

### <Solvent Removal>

[Emulsification Slurry 1] was charged into a vessel equipped with a stirrer and a thermometer, and the solvent was removed at 30° C. for 180 minutes to obtain [Solvent Removal Slurry 1]. The volume average particle diameter of the particles contained in [Solvent Removal Slurry 1] was 0.35 μm.

### <Aggregation>

After dropwise addition of 50 parts of a 10% magnesium sulfate solution to [Solvent Removal Slurry 1], the mixture was further stirred for 5 minutes. Then, the temperature was raised to 50° C., and when the particle diameter reached 5.0 μm, 140 parts of [Amorphous Polyester Resin B Dispersion Liquid 1] was added dropwise. After stirring for 30 minutes, 100 parts of a 10% sodium sulfate aqueous solution was added to terminate the aggregation step to obtain [Aggregation Slurry 1].

### <Fusion>

[Aggregation Slurry 1] was heated to 70° C. while stirring, and when the average circularity reached 0.960, which was the desired value, the mixture was cooled to obtain [Dispersion Slurry 1].

### <Washing and Drying>

After filtering 100 parts of [Dispersion Slurry 1] under reduced pressure, the following operations (1) to (4) were performed twice to obtain [Filter Cake 1].
(1): 100 parts of ion-exchanged water was added to the filter cake, mixed with a TK Homomixer (rotation speed: 12,000 rpm for 10 minutes), and then filtered.
(2): 100 parts of a 10% sodium hydroxide aqueous solution was added to the filter cake in (1) above, mixed with a TK Homomixer (rotation speed: 12,000 rpm for 30 minutes), and then filtered under reduced pressure.
(3): 100 parts of 10% hydrochloric acid was added to the filter cake in (2) above, mixed with a TK Homomixer (rotation speed: 12,000 rpm for 10 minutes), and then filtered.
(4): 300 parts of ion-exchanged water was added to the filter cake in (3) above, mixed with a TK Homomixer (rotation speed: 12,000 rpm for 10 minutes), and then filtered.

The obtained [Filter Cake 1] was dried with a circulation dryer at 45° C. for 48 hours and sieved with a mesh having an opening of 75 μm to obtain [Base Resin Particles 1].

### <External Additive Treatment Step>

Relative to 100 parts of [Base Resin Particles 1], 2.0 parts of hydrophobic silica (HDK (registered trademark) H2000, manufactured by Clariant AG) as an external additive was mixed using a Henschel mixer, and the mixture was passed through a sieve having an opening of 50 μm to obtain [Resin Particles 1].

The ratio of environmentally friendly components in [Resin Particles 1] was calculated using the following formula (VI).

$$( Ratio of environmentally friendly components \\ in [ Amorphous Polyester Resin A - 1 ] \times Parts by mass + Ratio of environmentally friendly components \\ in [ Crystalline Polyester Resin C - 1 ] \times Parts by mass + Ratio of environmentally friendly components in [ Wax 1 ] \times Parts by mass + Ratio of environmentally friendly components \\ in [ Amorphous Polyester Resin B - 1 ] \times Parts by mass ) / \\ ( Parts by mass of [ Amorphous Polyester Resin A - 1 ] + Parts by mass of \\ [ Crystalline Polyester Resin C - 1 ] + Parts by mass of [ Wax 1 ] + Parts by mass of [ Amorphous Polyester Resin B - 1 ) ] \times 100 \qquad ( VI )$$

### Example 2

[Resin Particles 2] were obtained in the same manner as in Example 1, except that, in <Oil Phase Preparation> of Example 1, [Wax Dispersion Liquid 1] was changed to [Wax Dispersion Liquid 2], [Crystalline Polyester Resin C Dispersion Liquid 1] was changed to [Crystalline Polyester Resin C Dispersion Liquid 2], and [Masterbatch 1] was changed to [Masterbatch 2], and in <Aggregation>, [Amorphous Polyester Resin B Dispersion Liquid 1] was changed to [Amorphous Polyester Resin B Dispersion Liquid 2].

### Example 3

[Resin Particles 3] were obtained in the same manner as in Example 1, except that, in <Oil Phase Preparation> of Example 1, 670 parts of [Amorphous Polyester Resin A-1] was changed to 550 parts of [Amorphous Polyester Resin A-2], 50 parts of [Wax Dispersion Liquid 1] was changed to 90 parts, and 50 parts of [Crystalline Polyester Resin C Dispersion Liquid 1] was changed to 90 parts, and in <Aggregation>, 140 parts of [Amorphous Polyester Resin B Dispersion Liquid 1] was changed to 180 parts of [Amorphous Polyester Resin B Dispersion Liquid 1].

### Example 4

[Resin Particles 4] were obtained in the same manner as in Example 1, except that, in <Oil Phase Preparation> of Example 1, 670 parts of [Amorphous Polyester Resin A-1] was changed to 640 parts of [Amorphous Polyester Resin A-3], 50 parts of [Wax Dispersion Liquid 1] was changed to 110 parts, and 50 parts of [Crystalline Polyester Resin C Dispersion Liquid 1] was changed to 110 parts of [Crystalline Polyester Resin C Dispersion Liquid 3], and in <Aggregation>, 140 parts of [Amorphous Polyester Resin B Dispersion Liquid 1] was changed to 50 parts of [Amorphous Polyester Resin B Dispersion Liquid 3].

### Example 5

[Resin Particles 5] were obtained in the same manner as in Example 1, except that, in <Oil Phase Preparation> of Example 1, [Amorphous Polyester Resin A-1] was changed to [Amorphous Polyester Resin A-4], and [Crystalline Polyester Resin C Dispersion Liquid 1] was changed to [Crystalline Polyester Resin C Dispersion Liquid 3], and in <Aggregation>, [Amorphous Polyester Resin B Dispersion Liquid 1] was changed to [Amorphous Polyester Resin B Dispersion Liquid 4].

### Example 6

[Resin Particles 6] were obtained in the same manner as in Example 1, except that, in <Oil Phase Preparation> of Example 1, 670 parts of [Amorphous Polyester Resin A-1] was changed to 640 parts of [Amorphous Polyester Resin A-5], 50 parts of [Wax Dispersion Liquid 1] was changed to 110 parts, 50 parts of [Crystalline Polyester Resin C Dispersion Liquid 1] was changed to 110 parts, and [Masterbatch 1] was changed to [Masterbatch 2], and in <Aggregation>, 140 parts of [Amorphous Polyester Resin B Dispersion Liquid 1] was changed to 50 parts of [Amorphous Polyester Resin B Dispersion Liquid 3].

### Example 7

[Resin Particles 7] were obtained in the same manner as in Example 1, except that, in <Oil Phase Preparation> of Example 1, 670 parts of [Amorphous Polyester Resin A-1] was changed to 640 parts, 50 parts of [Wax Dispersion Liquid 1] was changed to 110 parts of [Wax Dispersion Liquid 2], and 50 parts of [Crystalline Polyester Resin C Dispersion Liquid 1] was changed to 110 parts, and in <Aggregation>, 140 parts of [Amorphous Polyester Resin B Dispersion Liquid 1] was changed to 50 parts of [Amorphous Polyester Resin B Dispersion Liquid 3].

### Example 8

[Resin Particles 8] were obtained in the same manner as in Example 1, except that, in <Oil Phase Preparation> of Example 1, 670 parts of [Amorphous Polyester Resin A-1] was changed to 550 parts, 50 parts of [Wax Dispersion Liquid 1] was changed to 90 parts of [Wax Dispersion Liquid 2], and 50 parts of [Crystalline Polyester Resin C Dispersion Liquid 1] was changed to 90 parts of [Crystalline Polyester Resin C Dispersion Liquid 2], and in <Aggregation>, 140 parts of [Amorphous Polyester Resin B Dispersion Liquid 1] was changed to 180 parts of [Amorphous Polyester Resin B Dispersion Liquid 5].

### Comparative Example 1

[Resin Particles 9] were obtained in the same manner as in Example 1, except that, in <Oil Phase Preparation> of Example 1, [Amorphous Polyester Resin A-1] was changed to [Amorphous Polyester Resin A-6].

### Comparative Example 2

[Resin Particles 10] were obtained in the same manner as in Example 1, except that, in <Oil Phase Preparation> of Example 1, [Amorphous Polyester Resin A-1] was changed to [Amorphous Polyester Resin A-7], and in <Aggregation>, [Amorphous Polyester Resin B Dispersion Liquid 1] was changed to [Amorphous Polyester Resin B Dispersion Liquid 6].

### Comparative Example 3

[Resin Particles 11] were obtained in the same manner as in Example 1, except that, in <Oil Phase Preparation> of Example 1, 670 parts of [Amorphous Polyester Resin A-1] was changed to 740 parts of [Amorphous Polyester Resin A-8], 50 parts of [Wax Dispersion Liquid 1] was changed to 40 parts, 50 parts of [Crystalline Polyester Resin C Dispersion Liquid 1] was changed to 40 parts, and [Masterbatch 1] was changed to [Masterbatch 2], and in <Aggregation>, 140 parts of [Amorphous Polyester Resin B Dispersion Liquid 1] was changed to 90 parts of [Amorphous Polyester Resin B Dispersion Liquid 7].

### Comparative Example 4

[Resin Particles 12] were obtained in the same manner as in Example 1, except that, in <Oil Phase Preparation> of Example 1, 670 parts of [Amorphous Polyester Resin A-1] was changed to 640 parts, 50 parts of [Wax Dispersion Liquid 1] was changed to 110 parts of [Wax Dispersion Liquid 2], and 50 parts of [Crystalline Polyester Resin C Dispersion Liquid 1] was changed to 110 parts of [Crystalline Polyester Resin C Dispersion Liquid 3], and in <Aggregation>, 140 parts of [Amorphous Polyester Resin B Dispersion Liquid 1] was changed to 50 parts of [Amorphous Polyester Resin B Dispersion Liquid 3].

### Comparative Example 5

[Resin Particles 13] were obtained in the same manner as in Example 1, except that, in <Oil Phase Preparation> of Example 1, [Amorphous Polyester Resin A-1] was changed to [Amorphous Polyester Resin A-8], [Wax Dispersion Liquid 1] was changed to [Wax Dispersion Liquid 2], and [Crystalline Polyester Resin C Dispersion Liquid 1] was changed to [Crystalline Polyester Resin C Dispersion Liquid 2], and in <Aggregation>, [Amorphous Polyester Resin B Dispersion Liquid 1] was changed to [Amorphous Polyester Resin B Dispersion Liquid 8].

### Comparative Example 6

[Resin Particles 14] were obtained in the same manner as in Example 1, except that, in <Oil Phase Preparation> of Example 1, [Amorphous Polyester Resin A-1] was changed to [Amorphous Polyester Resin A-9], and in <Aggregation>, [Amorphous Polyester Resin B Dispersion Liquid 1] was changed to [Amorphous Polyester Resin B Dispersion Liquid 9].

### Comparative Example 7

[Resin Particles 15] were obtained in the same manner as in Example 1, except that, in <Oil Phase Preparation> of Example 1, [Amorphous Polyester Resin A-1] was changed to [Amorphous Polyester Resin A-9], and [Masterbatch 1] was changed to [Masterbatch 2], and in <Aggregation>, [Amorphous Polyester Resin B Dispersion Liquid 1] was changed to [Amorphous Polyester Resin B Dispersion Liquid 6].

### Comparative Example 8

[Resin Particles 16] were obtained in the same manner as in Example 1, except that, in <Oil Phase Preparation> of Example 1, 670 parts of [Amorphous Polyester Resin A-1] was changed to 640 parts of [Amorphous Polyester Resin A-9], 50 parts of [Wax Dispersion Liquid 1] was changed to 90 parts of [Wax Dispersion Liquid 2], and 50 parts of [Crystalline Polyester Resin C Dispersion Liquid 1] was changed to 90 parts, and in <Aggregation>, 140 parts of [Amorphous Polyester Resin B Dispersion Liquid 1] was changed to 90 parts of [Amorphous Polyester Resin B Dispersion Liquid 10].

### Comparative Example 9

[Resin Particles 17] were obtained in the same manner as in Example 1, except that, in <Oil Phase Preparation> of Example 1, [Amorphous Polyester Resin A-1] was changed to [Amorphous Polyester Resin A-9], and [Crystalline Polyester Resin C Dispersion Liquid 1] was changed to [Crystalline Polyester Resin C Dispersion Liquid 3].

### Comparative Example 10

[Resin Particles 18] were obtained in the same manner as in Example 1, except that, in <Oil Phase Preparation> of Example 1, [Amorphous Polyester Resin A-1] was changed to [Amorphous Polyester Resin A-7], and [Masterbatch 1] was changed to [Masterbatch 2], and in <Aggregation>, [Amorphous Polyester Resin B Dispersion Liquid 1] was changed to [Amorphous Polyester Resin B Dispersion Liquid 3].

### Comparative Example 11

[Resin Particles 19] were obtained in the same manner as in Example 1, except that, in <Oil Phase Preparation> of Example 1, [Amorphous Polyester Resin A-1] was changed to [Amorphous Polyester Resin A-9], and in <Aggregation>, [Amorphous Polyester Resin B Dispersion Liquid 1] was changed to [Amorphous Polyester Resin B Dispersion Liquid 10].

The configurations of the oil phase components and the characteristics in the aggregation step for Examples 1 to 8 and Comparative Examples 1 to 11 are illustrated in Table 10 below.

TABLE 10

| | | | | | | Blending Ratio [parts by mass] | | | | | |
|---|---|---|---|---|---|---|---|---|---|---|---|
| | Material Type | | | | | | | Crystal- | | | Environ- |
| | Amorphous | | Crystalline | | Amorphous | | | line | | Amorphous | mentally |
| Example / | Polyester | | Polyester | Pigment | Polyester | Amorphous | | Poly- | Pigment | Polyester | Friendly |
| Comparative | Resin A | | Resin C | Masterbatch | Resin B | Polyester | | ester | Master- | Resin | Component |
| Example No. | No. | Wax | No. | Type | No. | Resin A | Wax | Resin C | batch | B | Ratio [%] |
| Example 1 | A-1 | Wax 1 | C-1 | Masterbatch 1 | B-1 | 670 | 50 | 50 | 90 | 140 | 48 |
| Example 2 | A-1 | Wax 2 | C-2 | Masterbatch 2 | B-2 | 670 | 50 | 50 | 90 | 140 | 41 |
| Example 3 | A-2 | Wax 1 | C-1 | Masterbatch 1 | B-1 | 550 | 90 | 90 | 90 | 180 | 37 |
| Example 4 | A-3 | Wax 1 | C-1 | Masterbatch 1 | B-3 | 640 | 110 | 110 | 90 | 50 | 33 |
| Example 5 | A-4 | Wax 1 | C-3 | Masterbatch 1 | B-4 | 670 | 50 | 50 | 90 | 140 | 50 |
| Example 6 | A-5 | Wax 1 | C-1 | Masterbatch 2 | B-3 | 640 | 110 | 110 | 90 | 50 | 32 |
| Example 7 | A-1 | Wax 2 | C-1 | Masterbatch 1 | B-3 | 640 | 110 | 110 | 90 | 50 | 40 |
| Example 8 | A-1 | Wax 2 | C-2 | Masterbatch 1 | B-5 | 550 | 90 | 90 | 90 | 180 | 34 |
| Comparative | A-6 | Wax 1 | C-1 | Masterbatch 1 | B-1 | 670 | 50 | 50 | 90 | 140 | 32 |
| Example 1 | | | | | | | | | | | |
| Comparative | A-7 | Wax 1 | C-1 | Masterbatch 1 | B-6 | 670 | 50 | 50 | 90 | 140 | 27 |
| Example 2 | | | | | | | | | | | |
| Comparative | A-8 | Wax 1 | C-1 | Masterbatch 2 | B-7 | 740 | 40 | 40 | 90 | 90 | 11 |
| Example 3 | | | | | | | | | | | |
| Comparative | A-1 | Wax 2 | C-3 | Masterbatch 1 | B-3 | 640 | 110 | 110 | 90 | 50 | 36 |
| Example 4 | | | | | | | | | | | |
| Comparative | A-8 | Wax 2 | C-2 | Masterbatch 1 | B-8 | 670 | 50 | 50 | 90 | 140 | 7 |
| Example 5 | | | | | | | | | | | |
| Comparative | A-9 | Wax 1 | C-1 | Masterbatch 1 | B-9 | 670 | 50 | 50 | 90 | 140 | 51 |
| Example 6 | | | | | | | | | | | |
| Comparative | A-9 | Wax 1 | C-1 | Masterbatch 2 | B-6 | 670 | 50 | 50 | 90 | 140 | 58 |
| Example 7 | | | | | | | | | | | |
| Comparative | A-9 | Wax 2 | C-1 | Masterbatch 1 | B-10 | 640 | 90 | 90 | 90 | 90 | 52 |
| Example 8 | | | | | | | | | | | |
| Comparative | A-9 | Wax 1 | C-3 | Masterbatch 1 | B-1 | 670 | 50 | 50 | 90 | 140 | 57 |
| Example 9 | | | | | | | | | | | |
| Comparative | A-7 | Wax 1 | C-1 | Masterbatch 2 | B-3 | 670 | 50 | 50 | 90 | 140 | 19 |
| Example 10 | | | | | | | | | | | |
| Comparative | A-9 | Wax 1 | C-1 | Masterbatch 1 | B-10 | 670 | 50 | 50 | 90 | 140 | 57 |
| Example 11 | | | | | | | | | | | |

Further, with respect to each of the toners obtained in Examples 1 to 8 and Comparative Examples 1 to 11, evaluations of environmental friendliness, heat resistant storage stability, and filming resistance were performed by the following methods. The results are illustrated in Table 11 below.

### <Evaluation Methods>

### <<Environmental Friendliness>

Based on the calculated value of the environmentally friendly component ratio calculated by the above formula (VI), “environmental friendliness” was evaluated based on the following evaluation criteria.

### —Evaluation Criteria for “Environmental Friendliness”—

Good: 50% or more
Fair: 30% or more and less than 50%
Poor: Less than 30%<

### <<Charging Stability>>

In a room at normal temperature and normal humidity (temperature: 23.5° C., humidity: 60% RH), the humidity was adjusted in an open system for 30 minutes or more. After adding 6.000 g of the initial resin particles and 0.452 g of toner to a stainless steel container, the container was sealed. A friction-charged sample charged by an amplitude of approximately 1,100 times through operation for 1 minute at a scale of 150 using YS-LD [shaker manufactured by Yayoi Co., Ltd.] was measured by a common blow-off method [TB-200, manufactured by Toshiba Chemical Corp.]. Further, the humidity was adjusted in an open system for 24 hours under high-temperature and high-humidity conditions (temperature: 35° C., humidity: 70% RH), and then the humidity was adjusted in an open system for 30 minutes or more in a room at normal temperature and normal humidity (temperature: 23.5° C., humidity: 60% RH), and the measurement was performed in the same manner. The “charging stability” was evaluated based also on the amount of change in the charge.

### —Evaluation Criteria of “Charging Stability”—

Good: Less than 5 (μC/g)
Fair: 5 (μC/g) or more and less than 10 (μC/g)
Poor: 10 (μC/g) or more

### <<Low-Temperature Fixability>>

A carrier used in imagio MP C5503 (manufactured by Ricoh Co., Ltd.) and the resin particles obtained in Examples 1 to 8 and Comparative Examples 1 to 11 were mixed such that the concentration of the resin particles was 5% by mass to obtain a developer.

After charging the developer into a unit of imagio MP C5503 (manufactured by Ricoh Co., Ltd.), a rectangular solid image of 2 cm×15 cm was formed on PPC paper Type 6000 <70W> A4 T-grain (manufactured by Ricoh Co., Ltd.) such that the adhesion amount of the resin particles was 0.40 mg/cm². At this time, the surface temperature of a fixing roller was varied to observe whether or not cold offset, in which a developed residual image of the solid image is fixed to a location other than a desired location, occurred. A cold offset temperature (minimum fixing temperature) was determined, and the “low-temperature fixability” was evaluated based on the following evaluation criteria.

### —Evaluation Criteria for “Low-Temperature Fixability”—

Good: Cold offset temperature is 110° C. or higher and lower than 120° C.
Fair: Cold offset temperature is 120° C. or higher and lower than 130° C.
Poor: Cold offset temperature is 130° C.

### <<Heat Resistant Storage Stability>>

A 50-mL glass container was filled with each of the resin particles and left to stand in a constant-temperature bath at 50° C. for 24 hours. The resin particles were cooled to 24° C., and the penetration (mm) was measured by a penetration test (JIS K2235-1991), and the “heat resistant storage stability” was evaluated based on the following evaluation criteria. Note that, a larger value of the penetration indicates superior heat resistant storage stability, and if the penetration is less than 5 mm, a problem in use is highly likely to occur. Note that, herein, the penetration is expressed as a penetration depth (mm).

### —Evaluation Criteria for “Heat Resistant Storage Stability”—

Good: Penetration of 20 mm or more and less than 25 mm
Fair: Penetration of 10 mm or more and less than 20 mm
Poor: Penetration of less than 10 mm

TABLE 11

| | | | | Heat |
|---|---|---|---|---|
| | | | | Resistant |
| | Environmental | Charging | Low-Temperature | Storage |
| | Friendliness | Stability | Fixability | Stability |
| Example 1 | Fair | Fair | Fair | Good |
| Example 2 | Fair | Fair | Fair | Good |
| Example 3 | Fair | Fair | Fair | Good |
| Example 4 | Fair | Good | Good | Fair |
| Example 5 | Good | Fair | Fair | Good |
| Example 6 | Fair | Good | Good | Fair |
| Example 7 | Fair | Good | Good | Fair |
| Example 8 | Fair | Fair | Fair | Good |
| Comparative Example 1 | Fair | Fair | Fair | Poor |
| Comparative Example 2 | Poor | Poor | Poor | Good |
| Comparative Example 3 | Poor | Fair | Fair | Fair |
| Comparative Example 4 | Fair | Good | Poor | Fair |
| Comparative Example 5 | Poor | Fair | Fair | Good |
| Comparative Example 6 | Good | Good | Fair | Poor |
| Comparative Example 7 | Good | Poor | Poor | Good |
| Comparative Example 8 | Good | Poor | Good | Poor |
| Comparative Example 9 | Good | Fair | Poor | Poor |
| Comparative Example 10 | Poor | Good | Fair | Good |
| Comparative Example 11 | Good | Poor | Fair | Poor |

Embodiments of the present disclosure include, but are not limited to, the following aspects.

A first aspect is a resin particle containing a binder resin including an amorphous polyester resin A, an amorphous polyester resin B, and a crystalline polyester resin, wherein the resin particle has a core-shell structure including a core layer and a shell layer, the core layer contains the amorphous polyester resin A and the crystalline polyester resin, the shell layer contains the amorphous polyester resin B, a solubility parameter (SPa) of the amorphous polyester resin A, a solubility parameter (SPb) of the amorphous polyester resin B, and a solubility parameter (SPc) of the crystalline polyester resin satisfy relational expressions (1) to (3) below, and a content of environmentally friendly components in the resin particle is 30% or more.

$$Spa - Spc \leq 1.6 \qquad ( 1 )$$

$$0.2 \leq SPb - SPa \qquad ( 2 )$$

$$SPb \geq 11.6 \qquad ( 3 )$$

A second aspect is the resin particle according to the first aspect above, wherein the amorphous polyester resin A contains a structural unit derived from a carboxylic acid, and the carboxylic acid includes at least one type of biomass-derived dicarboxylic acid having 8 or more carbon atoms.

A third aspect is the resin particle according to the first or second aspect above, wherein the amorphous polyester resin A and/or the amorphous polyester resin B contains a sulfo group.

A fourth aspect is the resin particle according to any one of first to third aspects above, wherein a content of environmentally friendly components in the amorphous polyester resin B is 0%.

A fifth aspect is a method of manufacturing the resin particle according to any one of the first to fourth aspects above, which includes: preparing an oil phase in which an amorphous polyester resin A and a crystalline polyester resin are dissolved or dispersed in an organic solvent; adding water to the oil phase to cause phase inversion from a water-in-oil dispersion liquid to an oil-in-water dispersion liquid; aggregating particles in the oil-in-water dispersion liquid; and adding, after the aggregating, an aqueous dispersion of an amorphous polyester resin B to the oil-in-water dispersion liquid to aggregate the amorphous polyester resin B in the aqueous dispersion to form a shell layer.

A sixth aspect is the method according to the fifth aspect above, wherein the amorphous polyester resin A and/or the amorphous polyester resin B contains a sulfo group.

A seventh aspect is a toner resin particle containing the resin particle according to any one of the first to fourth aspects above.

An eighth aspect is a toner containing the toner resin particle according to the seventh aspect above.

A ninth aspect is the toner according to the eighth aspect, further containing an external additive.

A tenth aspect is a method of manufacturing a toner, which includes adding an external additive to the toner resin particle according to the seventh aspect above.

An eleventh aspect is a developer containing the toner according to the ninth aspect above.

A twelfth aspect is a toner storage unit containing the toner according to the ninth aspect above.

A thirteenth aspect is an image forming apparatus including: an electrostatic latent image bearer; an electrostatic latent image forming device to form an electrostatic latent image on the electrostatic latent image bearer; and a developing device including the toner according to the ninth aspect above to develop the electrostatic latent image formed on the electrostatic latent image bearer to form a visible image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A resin particle comprising:
a binder resin including an amorphous polyester resin A, an amorphous polyester resin B, and a crystalline polyester resin,
wherein the resin particle has a core-shell structure including a core layer and a shell layer,
the core layer contains the amorphous polyester resin A and the crystalline polyester resin,
the shell layer contains the amorphous polyester resin B,
a solubility parameter (SPa) of the amorphous polyester resin A, a solubility parameter (SPb) of the amorphous polyester resin B, and a solubility parameter (SPc) of the crystalline polyester resin satisfy relational expressions (1) to (3) below:
$$Spa - Spc \leq 1.6 ; \qquad ( 1 )$$
$$0.2 \leq SPb - SPa ; and \qquad ( 2 )$$
$$SPb \geq 11.6 , and \qquad ( 3 )$$
a content of environmentally friendly components in the resin particle is 30% or more.

2. The resin particle according to claim 1, wherein the amorphous polyester resin A contains a structural unit derived from a carboxylic acid, and the carboxylic acid includes at least one type of biomass-derived dicarboxylic acid having 8 or more carbon atoms.

3. The resin particle according to claim 1, wherein at least one of the amorphous polyester resin A or the amorphous polyester resin B contains a sulfo group.

4. The resin particle according to claim 1, wherein a content of environmentally friendly components in the amorphous polyester resin B is 0%.

5. A method of manufacturing the resin particle according to claim 1, the method comprising:
preparing an oil phase in which an amorphous polyester resin A and a crystalline polyester resin are dissolved or dispersed in an organic solvent;
adding water to the oil phase to cause phase inversion from a water-in-oil dispersion liquid to an oil-in-water dispersion liquid;
aggregating particles in the oil-in-water dispersion liquid; and
adding, after the aggregating, an aqueous dispersion of an amorphous polyester resin B to the oil-in-water dispersion liquid to aggregate the amorphous polyester resin B in the aqueous dispersion to form a shell layer.

6. The method according to claim 5, wherein at least one of the amorphous polyester resin A or the amorphous polyester resin B contains a sulfo group.

7. A toner resin particle comprising the resin particle according to claim 1.

8. A toner comprising the toner resin particle according to claim 7.

9. The toner according to claim 8, further comprising an external additive.

10. A method of manufacturing a toner, the method comprising:
adding an external additive to the toner resin particle according to claim 7.

11. A developer comprising the toner according to claim 9.

12. A toner storage unit comprising the toner according to claim 9.

13. An image forming apparatus comprising:
an electrostatic latent image bearer;
an electrostatic latent image forming device to form an electrostatic latent image on the electrostatic latent image bearer; and
a developing device including the toner according to claim 9 to develop the electrostatic latent image formed on the electrostatic latent image bearer to form a visible image.
